(19) United States
(12) Patent Application Publication
(10) Pub. No.: US 2026/0267246 A1
(43) Pub. Date: Sep. 10, 2026

(54) ELECTROPHOTOGRAPHIC PHOTORECEPTOR, METHOD OF PRODUCING AN ELECTROPHOTOGRAPHIC PHOTORECEPTOR, PROCESS CARTRIDGE, AND IMAGE FORMING APPARATUS

(71) Applicant: KYOCERA DOCUMENT SOLUTIONS INC., OSAKA-SHI, OSAKA (JP)

(72) Inventors: KATSUNORI TERAOKA, OSAKA-SHI, OSAKA (JP); DAISUKE KUBOSHIMA, OSAKA-SHI, OSAKA (JP); YOSHITAKA IMANAKA, OSAKA-SHI, OSAKA (JP); MAKOTO SHISHIDO, OSAKA-SHI, OSAKA (JP); TOMOFUMI SHIMIZU, OSAKA-SHI, OSAKA (JP)

(21) Appl. No.: 19/166,481

(22) PCT Filed: May 20, 2024
(86) PCT No.: PCT/JP2024/018494

§ 371 Date: Sep. 18, 2025

(30) Foreign Application Priority Data
Mar. 23, 2023 (JP) 2023-046536

(51) Int. Cl. G03G 5/147; G03G 5/06; G03G 5/09

(52) U.S. Cl. CPC G03G 5/14734; G03G 5/0661; G03G 5/0662; G03G 5/09; G03G 5/14704; G03G 2215/00957; G03G 2215/00962; G03G 2221/183

(57) ABSTRACT

An electrophotographic photoreceptor includes a conductive substrate, a photosensitive layer, and a protective layer. The photosensitive layer includes a charge generating agent, a hole transporting agent, and a binder resin. The hole transporting agent has two or less chain ethene-1,2-diyl groups or no chain ethene-1,2-diyl group. The protective layer is a top surface layer of the electrophotographic photoreceptor and includes a photocurable resin. A ratio A/B of first absorbance A of the protective layer to second absorbance B of the protective layer is 0.160 or less, the first absorbance and the second absorbance being measured by Fourier transform infrared spectroscopy. The first absorbance is the highest absorbance in a wavenumber range of 1627 cm⁻¹ or more and 1647 cm⁻¹ or less. The second absorbance is the highest absorbance in a wavenumber range of more than 1647 cm⁻¹ and 1800 cm⁻¹ or less.

### FIELD OF THE DISCLOSURE

The present invention relates to an electrophotographic photoreceptor, a method of producing an electrophotographic photoreceptor, a process cartridge, and an image forming apparatus.

### BACKGROUND OF THE DISCLOSURE

When an image forming apparatus including an electrophotographic photoreceptor is used to form images repeatedly, the electrophotographic photoreceptor gradually wears out in some cases. In order to suppress wear and extend the lifetime of the electrophotographic photoreceptor, a hard protective layer is provided on the surface of the electrophotographic photoreceptor in some cases. For example, the electrophotographic photoreceptor disclosed in Patent Literature 1 includes a photosensitive layer that contains a charge generating substance and a charge transporting substance in the same layer on a conductive support. A protective layer is provided on the photosensitive layer. The volume resistivity of the protective layer is smaller than the volume resistivity of the photosensitive layer.

### CITATION LIST

### Patent Literature

Patent Literature 1: Japanese Patent Application Laid-open No. 2010-286707

### SUMMARY OF THE DISCLOSURE

### Technical Problem

However, the electrophotographic photoreceptor disclosed in Patent Literature 1 is not intended to include a photocurable resin in the protective layer thereof. The present inventors' study has revealed that in the case where the protective layer includes a photocurable resin, the potential stability of the electrophotographic photoreceptor tends to decrease and a curing failure of the protective layer is likely to occur.

The present invention has been made in view of the above problem, and an object thereof is to provide an electrophotographic photoreceptor that is capable of sufficiently curing a protective layer even in the case where the protective layer includes a photocurable resin and has excellent potential stability, and a method of producing the same. Further, another object of the present invention is to provide a process cartridge and an image forming apparatus including such an electrophotographic photoreceptor.

### Solution to Problem

The electrophotographic photoreceptor according to the present invention includes a conductive substrate, a photosensitive layer, and a protective layer. The photosensitive layer includes a charge generating agent, a hole transporting agent, and a binder resin. The hole transporting agent has two or less chain ethene-1,2-diyl groups or no chain ethene-1,2-diyl group. The protective layer is a top surface layer of the electrophotographic photoreceptor and includes a photocurable resin. A ratio A/B of first absorbance A of the protective layer to second absorbance B of the protective layer is 0.160 or less, the first absorbance and the second absorbance being measured by Fourier transform infrared spectroscopy. The first absorbance is the highest absorbance in a wavenumber range of 1627 cm⁻¹ or more and 1647 cm⁻¹ or less. The second absorbance is the highest absorbance in a wavenumber range of more than 1647 cm⁻¹ and 1800 cm⁻¹ or less.

A method of producing an electrophotographic photoreceptor according to the present invention is a method of producing the above electrophotographic photoreceptor. The method of producing an electrophotographic photoreceptor according to the present invention includes a protective layer forming step of forming the protective layer including the photocurable resin on the photosensitive layer. In the protective layer forming step, the photocurable resin is formed by applying ultraviolet rays to at least one of a monomer or an oligomer on the photosensitive layer to polymerize the at least one of the monomer or the oligomer.

A process cartridge according to the present invention includes at least one selected from the group consisting of a charging device, an exposure device, a development device, a transfer device, a cleaning member, a rubbing roller, and a static elimination device, and the above electrophotographic photoreceptor.

An image forming apparatus according to the present invention includes an image carrier, a charging device that charges a surface of the image carrier, an exposure device that exposes the charged surface of the image carrier to form an electrostatic latent image on the surface of the image carrier, a development device that supplies a toner to the surface of the image carrier to develop the electrostatic latent image as a toner image, and a transfer device that transfers the toner image from the image carrier onto a to-be-transferred body. The image carrier is the above electrophotographic photoreceptor.

### Advantageous Effects of Invention

The electrophotographic photoreceptor according to the present invention and the electrophotographic photoreceptor produced by the production method according to the present invention are capable of sufficiently curing a protective layer even in the case where the protective layer includes a photocurable resin and have excellent potential stability. Further, the process cartridge according to the present invention and the image forming apparatus according to the present invention include an electrophotographic photoreceptor that is capable of sufficiently curing a protective layer even in the case where the protective layer includes a photocurable resin and has excellent potential stability.

### BRIEF DESCRIPTION OF THE DRAWINGS

FIG. 1 is a partial cross-sectional view of a single-layer electrophotographic photoreceptor that is an example of an electrophotographic photoreceptor according to a first embodiment of the present invention.

FIG. 2 is a partial cross-sectional view of a single-layer electrophotographic photoreceptor that is an example of the electrophotographic photoreceptor according to the first embodiment of the present invention.

FIG. 3 is a partial cross-sectional view of a stacked electrophotographic photoreceptor that is an example of the electrophotographic photoreceptor according to the first embodiment of the present invention.

FIG. 4 is a partial cross-sectional view of a stacked electrophotographic photoreceptor that is an example of the electrophotographic photoreceptor according to the first embodiment of the present invention.

FIG. 5 is a partial cross-sectional view of a stacked electrophotographic photoreceptor that is an example of the electrophotographic photoreceptor according to the first embodiment of the present invention.

FIG. 6 shows an absorption spectrum of a protective layer included in a photoreceptor according to Example 2, which is measured by Fourier transform infrared spectroscopy.

FIG. 7 shows an absorption spectrum of a hole transporting agent before and after predetermined ultraviolet irradiation, which is measured by ultraviolet-visible spectroscopy, and this hole transporting agent is included in a photosensitive layer included in a photoreceptor according to Example 4.

FIG. 8 is a diagram showing an example of an image forming apparatus according to a third embodiment of the present invention.

FIG. 9 is a diagram showing an example of a configuration of a development device shown in FIG. 8.

### DETAILED DESCRIPTION OF THE EXEMPLARY EMBODIMENTS

Hereinafter, embodiments of the present invention will be described in detail. However, the present invention is not limited to the following embodiments and can be implemented with appropriate modifications within the scope of the present invention.

Acrylic and methacrylic are collectively referred to as “(meth) acrylic” in some cases. Acrylate and methacrylate are collectively referred to as “(meth)acrylate” in some cases. Acryloyl and methacryloyl are collectively referred to as “(meth)acryloyl” in some cases. Unless otherwise specified, the hydroxyl value is a value measured in accordance with “JIS (Japanese Industrial Standard) K0070-1992”. Unless otherwise specified, the number average primary particle size is a number average value of an equivalent circle diameter (Heywood diameter: diameter of a circle having the same area as the projected area of a primary particle) of a primary particle measured using a scanning electron microscope. The number average primary particle size is, for example, a number average value of equivalent circle diameters of 100 primary particles. Unless otherwise specified, the BET specific surface area is a value measured by a BET method using nitrogen adsorption in accordance with “JIS (Japanese Industrial Standard) Z8830:2001 Determination of the specific surface area of powders (solids) by gas adsorption-BET method”. The term “-based” is added after the compound name to collectively refer to the compound and derivatives thereof in some cases. Further, in the case of adding the term “-based” after a compound to refer to a polymer name, it means that the repeating unit of the polymer is derived from the compound or a derivative thereof. Further, a “general formula” and a “chemical formula” are collectively referred to as a “formula”. The phrase “each independently” in the description of the formula means that they may indicate the same group or different groups. Unless otherwise specified, the components described in the present specification may each be used alone, or two or more of them may be used in combination. For example, the phrase “at least one of A, B, or C” is synonymous with the phrase “at least one selected from the group consisting of A, B, and C”. The phrase “at least one type of A, B, and C” is synonymous with the phrase “at least one selected from the group consisting of A, B, and C”. Note that A, B, and C are merely an examples and can be replaced with other terms.

### First Embodiment: Electrophotographic Photoreceptor

A first embodiment of the present invention relates to an electrophotographic photoreceptor (hereinafter, referred to as a photoreceptor in some cases). The photoreceptor according to the first embodiment includes a conductive substrate, a photosensitive layer, and a protective layer. The photosensitive layer includes a charge generating agent, a hole transporting agent, and a binder resin. The hole transporting agent has two or less chain ethene-1,2-diyl groups. Alternatively, the hole transporting agent has no chain ethene-1,2-diyl group. The protective layer is a top surface layer of the photoreceptor. The protective layer includes a photocurable resin. A ratio A/B of first absorbance A of the protective layer to second absorbance B of the protective layer is 0.160 or less, the first absorbance (hereinafter, referred to as “first absorbance A” in some cases) and the second absorbance (hereinafter, referred to as “first absorbance B” in some cases) being measured by Fourier transform infrared spectroscopy. The first absorbance A is the highest absorbance in a wavenumber range of 1627 cm⁻¹ or more and 1647 cm⁻¹ or less. The second absorbance B is the highest absorbance in a wavenumber range of more than 1647 cm⁻¹ and 1800 cm⁻¹ or less. Hereinafter, the “chain ethene-1,2-diyl group” will be referred to as a “predetermined double bond” in some cases. The “ratio A/B of the first absorbance A of the protective layer to the second absorbance B of the protective layer, the first absorbance A and the second absorbance B being measured by Fourier transform infrared spectroscopy” will be referred to simply as a “ratio A/B” in some cases.

By having the above configuration, the photoreceptor according to the first embodiment is capable of sufficiently curing a protective layer even in the case where the protective layer includes a photocurable resin and has excellent potential stability. The reasons for this are presumed to be as follows.

The protective layer of the photoreceptor according to the first embodiment includes a photocurable resin. In the protective layer forming step, the photocurable resin is formed by applying ultraviolet rays to at least one of a monomer or an oligomer on the photosensitive layer to polymerize (photocuring reaction) the at least one of the monomer or the oligomer. As a result, the protective layer is cured to form a protective layer including the photocurable resin. Hereinafter, the “monomer and oligomer” will be referred to as a “monomer and the like” in some cases. Note that the protective layer forming step will be described in a second embodiment.

However, the ultraviolet rays applied in the protective layer forming step cleave the predetermined double bond of the hole transporting agent included in the photosensitive layer to decompose the hole transporting agent in some cases. When the hole transporting agent is decomposed, the potential stability of the photoreceptor decreases. The present inventors have conducted extensive research and have found that a hole transporting agent having two or less predetermined double bonds and a hole transporting agent having no predetermined double bond are difficult to decompose due to ultraviolet rays. When the photosensitive layer includes a hole transporting agent having two or less predetermined double bonds or a hole transporting agent having no predetermined double bond, it is possible to suppress decomposition of the hole transporting agent due to ultraviolet rays. As a result, it is possible to smoothly transport holes by the hole transporting agent and improve the potential stability of the photoreceptor according to the first embodiment.

Further, the ratio A/B of the protective layer included in the photoreceptor according to the first embodiment is 0.160 or less. The first absorbance A is absorbance of the peak based on a polymerizable functional group that reacts in the above photocuring reaction (e.g., a vinyl group in the case where the photocuring reaction is an addition polymerization reaction of a vinyl group). As the photocuring reaction progresses, the number of polymerizable functional groups decreases and the first absorbance A decreases. Meanwhile, the second absorbance B is absorbance of the peak based on a non-polymerizable functional group that does not react in the photocuring reaction (e.g., a carbonyl group in the case where the photocuring reaction is an addition polymerization reaction of a vinyl group). Even if the photocuring reaction progresses, the number of non-polymerizable functional groups is unchanged and the second absorbance B is constant. From the above, the ratio A/B indicates the degree of progress of the photocuring reaction. The smaller the ratio A/B, the more the number of polymerizable functional groups decreases, indicating that the photocuring reaction is progressing more. When the ratio A/B is 0.160 or less, the number of polymerizable functional groups is sufficiently reduced, and thus, it is difficult for the radicals generated in the photocuring reaction to remain in the protective layer. As a result, it is possible to suppress a decrease in potential stability of the photoreceptor. Further, when the ratio A/B is 0.160 or less, the photocuring reaction is sufficiently progressed, and thus, the protective layer can be sufficiently cured.

The reason why the photoreceptor according to the first embodiment is capable of sufficiently curing a protective layer even in the case where the protective layer includes a photocurable resin and has excellent potential stability has bene described above. The photoreceptor will be further described below.

The photoreceptor is, for example, a single-layer electrophotographic photoreceptor (hereinafter, referred to as a single-layer photoreceptor in some cases) or a stacked electrophotographic photoreceptor (hereinafter, referred to as a stacked photoreceptor in some cases).

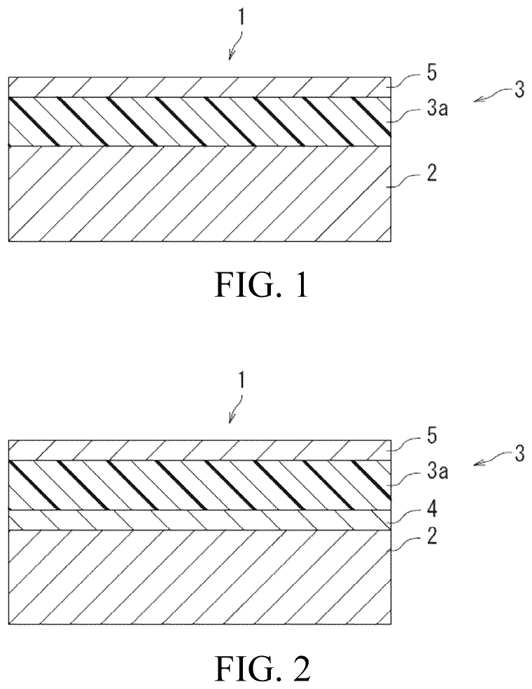

A structure of a single-layer photoreceptor 1 that is an example of a photoreceptor will be described below with reference to FIG. 1 and FIG. 2. FIG. 1 and FIG. 2 are each a partial cross-sectional view of the single-layer photoreceptor 1. As shown in FIG. 1, the single-layer photoreceptor 1 includes, for example, a conductive substrate 2, a photosensitive layer 3, and a protective layer 5. The photosensitive layer 3 is a single-layer photosensitive layer (hereinafter, referred to as a single-layer photosensitive layer in some cases) 3a. In the example shown in FIG. 1, the single-layer photosensitive layer 3a is provided on the conductive substrate 2 and the protective layer 5 is provided on the single-layer photosensitive layer 3a. The single-layer photosensitive layer 3a is provided directly on the conductive substrate 2. The protective layer 5 is the top surface layer of the single-layer photoreceptor 1.

As shown in FIG. 2, the single-layer photoreceptor 1 may further include an intermediate layer 4 (undercoat layer), in addition to the conductive substrate 2, the single-layer photosensitive layer 3a, and the protective layer 5. In the example shown in FIG. 2, the intermediate layer 4 is provided on the conductive substrate 2, the single-layer photosensitive layer 3a is provided on the intermediate layer 4, and the protective layer 5 is provided on the single-layer photosensitive layer 3a. The single-layer photosensitive layer 3a is provided above the conductive substrate 2 via the intermediate layer 4.

The thickness of the single-layer photosensitive layer 3a is not particularly limited, but is favorably 5 μm or more and 100 μm or less, more favorably 10 μm or more and 50 μm or less.

The thickness of the protective layer 5 is not particularly limited, but is favorably 2 μm or more, more favorably 2 μm or more and 30 μm or less, and still more favorably 2 μm or more and 10 μm or less. In the examples shown in FIG. 1 and FIG. 2, the protective layer 5 is one layer. However, the protective layer 5 may include a plurality of layers. In the case where the protective layer 5 includes a plurality of layers, at least the top surface layer, of the plurality of layers, includes a photocurable resin. The structure of the single-layer photoreceptor 1 that is an example of a photoreceptor has been described above with reference to FIG. 1 and FIG. 2.

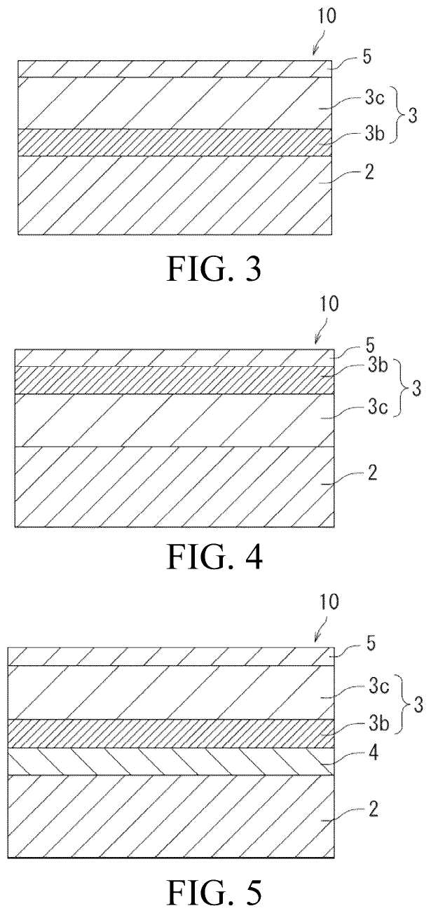

A structure of a stacked photoreceptor 10 that is an example of a photoreceptor will be described below with reference to FIG. 3 to FIG. 5. FIG. 3 to FIG. 5 are each a partial cross-sectional view of the stacked photoreceptor 10. As shown in FIG. 3, the stacked photoreceptor 10 includes, for example, the conductive substrate 2, the photosensitive layer 3, and the protective layer 5. The photosensitive layer 3 includes a charge generating layer 3b and a charge transporting layer 3c. In the example shown in FIG. 3, the charge generating layer 3b is provided on the conductive substrate 2, the charge transporting layer 3c is provided on the charge generating layer 3b, and the protective layer 5 is provided on the charge transporting layer 3c. However, as shown in FIG. 4, in the stacked photoreceptor 10, the charge transporting layer 3c may be provided on the conductive substrate 2, the charge generating layer 3b may be provided on the charge transporting layer 3c, and the protective layer 5 may be provided on the charge generating layer 3b. In the examples shown in FIG. 3 and FIG. 4, the photosensitive layer 3 is provided directly on the conductive substrate 2. The protective layer 5 is the top surface layer of the stacked photoreceptor 10.

As shown in FIG. 5, the stacked photoreceptor 10 may further include the intermediate layer 4 (undercoat layer), in addition to the conductive substrate 2, the photosensitive layer 3, and the protective layer 5. In the example shown in FIG. 5, the intermediate layer 4 is provided on the conductive substrate 2, the charge generating layer 3b is provided on the intermediate layer 4, the charge transporting layer 3c is provided on the charge generating layer 3b, and the protective layer 5 is provided on the charge transporting layer 3c. The photosensitive layer 3 (e.g., the charge generating layer 3b) is provided above the conductive substrate 2 via the intermediate layer 4.

The thickness of the charge generating layer 3b is not particularly limited, but is favorably 0.01 μm or more and 5 μm or less, more favorably 0.1 μm or more and 3 μm or less. In the examples shown in FIG. 3 to FIG. 5, the charge generating layer 3b is one layer. However, the charge generating layer 3b may include a plurality of layers.

The thickness of the charge transporting layer 3c is not particularly limited, but is favorably 2 μm or more and 100 μm or less, more favorably 5 μm or more and 50 μm or less. In the examples shown in FIG. 3 to FIG. 5, the charge transporting layer 3c is one layer. However, the charge transporting layer 3c may include a plurality of layers.

Since the protective layer 5 included in the stacked photoreceptor 10 is similar to the protective layer 5 included in the single-layer photoreceptor 1, description thereof is omitted. The structure of the stacked photoreceptor 10 that is an example of a photoreceptor has been described above with reference to FIG. 3 to FIG. 5.

### <Protective Layer>

The protective layer includes a photocurable resin. The protective layer favorably further includes a metal oxide. Further, the protective layer may include a polymerization initiator used for the photocuring reaction. The protective layer may further include an additive as necessary.

### (Ratio A/B)

As described above, the ratio A/B is 0.160 or less. In order to sufficiently cure the protective layer, the ratio A/B is favorably 0.155 or less, more favorably 0.150 or less. In the protective layer forming step, in order to suitably suppress decomposition of the hole transporting agent due to irradiation of ultraviolet rays, the ratio A/B is favorably 0.000 or more, more favorably 0.100 or more.

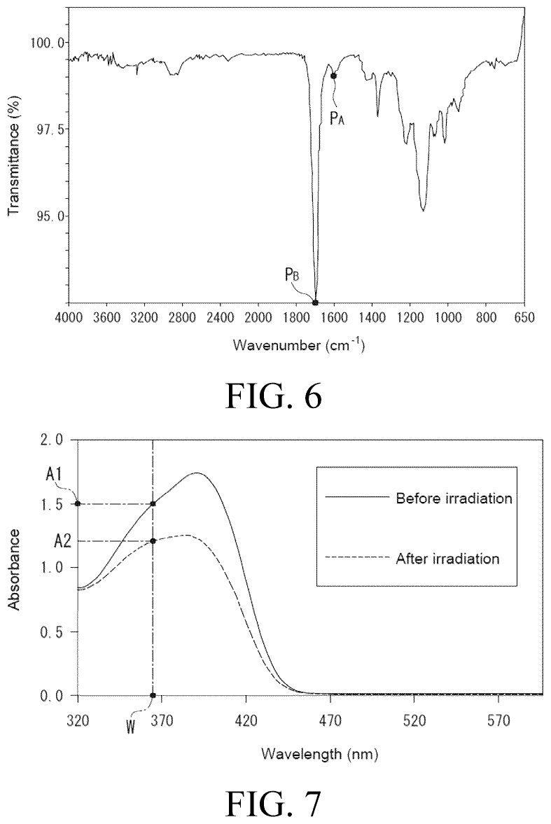

A method of measuring the ratio A/B will be described below with reference to FIG. 6. FIG. 6 shows an absorption spectrum of the protective layer of a photoreceptor according to Example 2 described below. This absorption spectrum is measured by Fourier transform infrared spectroscopy (FT-IR). In FIG. 6, the horizontal axis indicates a wavenumber (unit: cm⁻¹) and the vertical axis indicates transmittance (%). In the spectrum shown in FIG. 6, a peak P_{A} indicating the lowest transmittance within the wavenumber range of 1627 cm⁻¹ or more and 1647 cm⁻¹ or less and a peak P_{B} indicating the lowest transmittance within the wavenumber range of more than 1647 cm⁻¹ and 1800 cm⁻¹ or less can be observed. Transmittance % T_{A} of the peak P_{A} and transmittance % T_{B} of the peak P_{B} are read from the spectrum shown in FIG. 6. The first absorbance A is calculated from the transmittance % T_{A} of the peak P_{A} and the second absorbance B is calculated from the transmittance % T_{B} on the basis of a calculation formula “absorbance=−Log t” in accordance with the Lambert-Beer law. Note that a value that has not been converted into % (e.g., % T_{A}/100 or % T_{B}/100) is substituted for t in the calculation formula. The calculated first absorbance A corresponds to the highest absorbance in the wavenumber range of 1627 cm⁻¹ or more and 1647 cm⁻¹ or less. The calculated second absorbance B corresponds to the highest absorbance within the wavenumber range of more than 1647 cm⁻¹ and 1800 cm⁻¹ or less. The ratio A/B is calculated from the first absorbance A and the second absorbance B on the basis of a calculation formula “ratio A/B=first absorbance A/second absorbance B”. Note that although measurement is performed in the transmittance mode of the FT-IR analyzer in the example shown in FIG. 6, measurement may be performed in the absorbance mode to directly obtain the ratio A/B.

The higher the light energy of ultraviolet rays to be applied in the protective layer forming step, the more the photocuring reaction progresses, and the lower the ratio A/B tends to be. Further, the ratio A/B can be adjusted also by changing at least one of the monomer and the like for forming the photocurable resin.

### (Photocurable Resin)

Examples of the photocurable resin include a (meth)acrylic resin and an epoxy resin. The photocurable resin has a polymerizable functional group. The (meth)acrylic resin has a vinyl group as a polymerizable functional group. The epoxy resin has an epoxy group as a polymerizable functional group. The (meth)acrylic resin is favorable as a photocurable resin because the photocuring reaction stops when irradiation of ultraviolet rays is stopped, and the progress of the photocuring reaction can be easily controlled.

The photocurable resin favorably has a vinyl group and a carbonyl group. In the case where such a photocurable resin is included in the protective layer, the first absorbance A is, for example, absorbance of the peak based on the vinyl group (more specifically, C═C stretching vibration of a vinyl group), and the second absorbance B is, for example, absorbance of the peak based on the carbonyl group (more specifically, carbonyl absorption). The photocurable resin having a vinyl group and a carbonyl group is, for example, a (meth)acrylic resin.

The photocurable resin includes a repeating unit derived from (meth)acrylic acid ester, and this (meth)acrylic acid ester favorably has 2 or more and 6 or less vinyl groups. Hereinafter, “(meth)acrylic acid ester having 2 or more and 6 or less vinyl groups” will be referred to as “multifunctional group acrylic acid ester” in some cases. The multifunctional group acrylic acid ester favorably has 3 or more and 6 or less vinyl groups.

Examples of the multifunctional group acrylic acid ester include a trimethylolpropane triacrylate, a glycerin triacrylate, a tris-(2-acryloxyethyl) isocyanurate, a pentaerythritol triacrylate, a pentaerythritol tetraacrylate, a ditrimethylolpropane tetraacrylate, a dipentaerythritol pentaacrylate, and a dipentaerythritol hexaacrylate. These multifunctional group acrylic acid esters may be ethoxylated.

The multifunctional group acrylic acid ester is favorably at least one selected from the group consisting of a pentaerythritol triacrylate, a pentaerythritol tetraacrylate, a dipentaerythritol pentaacrylate, and a dipentaerythritol hexaacrylate, more favorably one or two of them. The multifunctional group acrylic acid ester is favorably a mixture of a pentaerythritol triacrylate and a pentaerythritol tetraacrylate. The content ratio of the pentaerythritol triacrylate occupied in the mixture of the pentaerythritol triacrylate and the pentaerythritol tetraacrylate is favorably 40 mass % or more and 60% or less. The multifunctional group acrylic acid ester is also favorably a mixture of a dipentaerythritol pentaacrylate and a dipentaerythritol hexaacrylate.

The pentaerythritol triacrylate, the pentaerythritol tetraacrylate, the dipentaerythritol pentaacrylate, and the dipentaerythritol hexaacrylate are respectively compounds represented by the formulae (EA-1), (EA-2), (EA-3), and (EA-4).

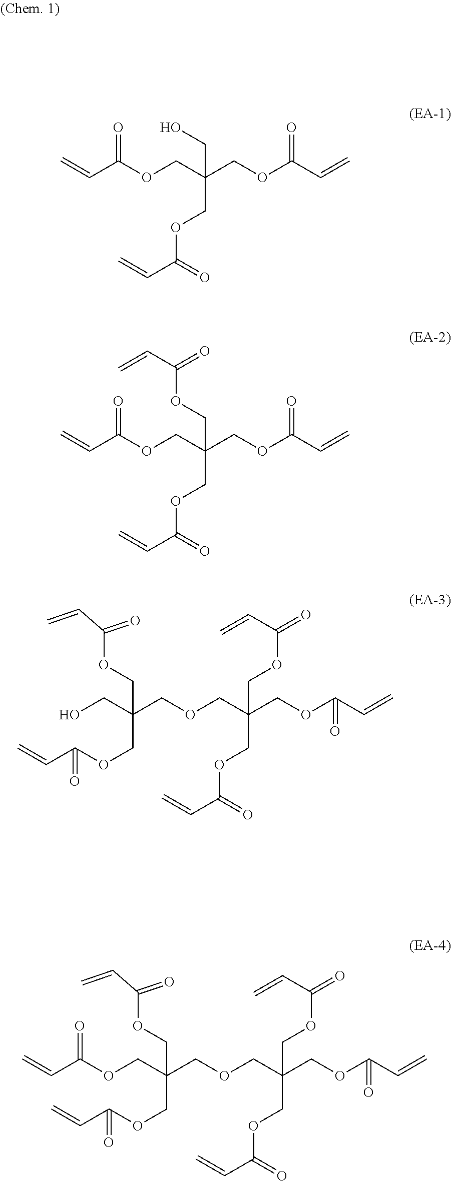

Repeating units represented by the formulae (EA-1a), (EA-2a), (EA-3a), and (EA-4a) are respectively formed from the compounds represented by the formulae (EA-1), (EA-2), (EA-3), and (EA-4), which are monomers, by the photocuring reaction (more specifically, an addition polymerization reaction of a vinyl group).

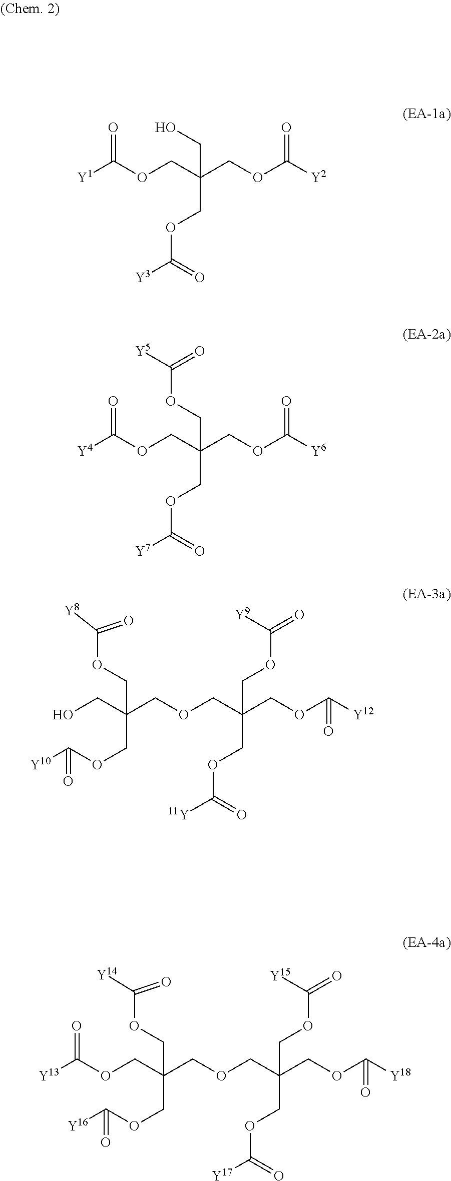

At least one of Y¹ to Y³ in the formula (EA-1a) represents a group represented by the formula (Y-b), and the remainder(s) of the at least one of Y¹ to Y³ represent(s) a group represented by the formula (Y-a). At least one of Y⁴ to Y⁷ in the formula (EA-2a) represents a group represented by the formula (Y-b), and the remainder(s) of the at least one of Y⁴ to Y⁷ represent(s) a group represented by the formula (Y-a). At least one of Y⁸ to Y¹² in the formula (EA-3a) represents a group represented by the formula (Y-b), and the remainder(s) of the at least one of Y⁸ to Y¹² represent(s) a group represented by the formula (Y-a). At least one of Y¹³ to Y¹⁸ in the formula (EA-3a) represents a group represented by the formula (Y-b), and the remainder(s) of the at least one of Y¹³ to Y¹⁸ represent(s) a group represented by the formula (Y-a).

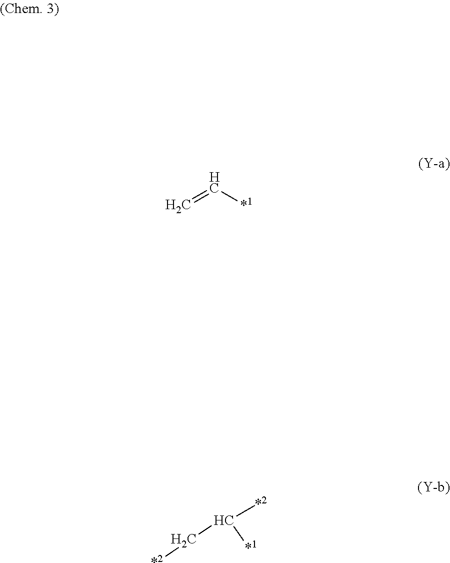

*¹ in the formulae (Y-a) and (Y-b) represents atomic bonding to be bonded to a carbon atom of a carbonyl group in the formulae (EA-1a) to (EA-4a). *² in the formula (Y-b) represents atomic bonding to be bonded to *² of the group represented by the formula (Y-b) of another repeating unit. That is, *² of the group represented by the formula (Y-b) of one repeating unit and *² of the group represented by the formula (Y-b) of another repeating unit are bonded to each other.

The double bond of the group represented by the formula (Y-a) is cleaved by the photocuring reaction (more specifically, an addition polymerization reaction of a vinyl group) to form the group represented by the formula (Y-b). Therefore, as the photocuring reaction (more specifically, an addition polymerization reaction of a vinyl group) progresses, the group represented by the formula (Y-a) decreases and the group represented by the formula (Y-b) increases.

The hydroxyl value of the multifunctional group acrylic acid ester is favorably 1 mgKOH/g or more and 50 mgKOH/g or less, more favorably 5 mgKOH/g or more and 15 mgKOH/g or less.

The content ratio of the repeating unit derived from multifunctional group acrylic acid ester occupied in all repeating units included in the photocurable resin is favorably 60 mass % or more (i.e., 60 mass % or more and 100 mass % or less), more favorably 70 mass % or more and 100 mass % or less, still more favorably 80 mass % or more and 100 mass % or less, still more favorably 90 mass % or more and 100 mass % or less, and particularly favorably 100 mass %. When the content ratio of the repeating unit derived from multifunctional group acrylic acid ester is 60 mass % or more, the number of polymerizable functional groups that react in the photocuring reaction is large and the photocuring reaction can be promoted.

The photocurable resin may further include a repeating unit derived from urethane (meth)acrylate, in addition to the repeating unit derived from multifunctional group acrylic acid ester. The urethane (meth)acrylate has a urethane bond (—O—CO—NH—) and a (meth)acryloyloxy group. The number of vinyl groups of the urethane (meth)acrylate is less than the number of vinyl groups of the multifunctional group acrylic acid ester. The number of vinyl groups of the urethane (meth)acrylate is, for example, one. Note that the multifunctional group acrylic acid ester described above does not have a urethane bond.

Examples of commercial products that can be used as urethane (meth)acrylate include U-2PPA, U-6LPA, U-200PA, UA-33H, U-10HA, U-10PA, and U-15HA manufactured by SHIN-NAKAMURA CHEMICAL CO, LTD. and 8FS-001 and 8SS-723 manufactured by TAISEI FINE CHEMICAL CO., LTD.

In the case where the photocurable resin further includes the repeating unit derived from urethane (meth)acrylate, the content ratio of the repeating unit derived from urethane (meth)acrylate occupied in the total of the repeating unit derived from multifunctional group acrylic acid ester and the repeating unit derived from urethane (meth)acrylate is favorably 40 mass % or more and 60 mass % or less. Further, the total content ratio of the repeating unit derived from multifunctional group acrylic acid ester and the repeating unit derived from urethane (meth)acrylate occupied in all repeating units included in the photocurable resin is favorably 90 mass % or more, more favorably 95 mass % or more, and particularly favorably 100 mass %.

In addition to multifunctional group acrylic acid ester and urethane (meth)acrylate, a monomer and the like other than these (hereinafter, referred to as a different monomer and the like in some cases) may be further included as the monomer and the like for forming a photocurable resin. Examples of the different monomer and the like include acrylic acid ester having one vinyl group. The content ratio of the photocurable resin occupied in the protective layer is favorably 50 mass % or more and 99 mass % or less, more favorably 70 mass % or more and 90 mass % or less, with respect to the mass of the protective layer.

### (Metal Oxide)

Examples of the metal oxide include alumina, zinc oxide, titanium oxide, and a metal oxide having conductivity (e.g., phosphorus-doped tin oxide and antimony-doped tin oxide). As the metal oxide, at least one selected from the group consisting of alumina, phosphorus-doped tin oxide, and antimony-doped tin oxide is favorable, and two or more of them are more favorable. The metal oxide is included in, for example, the protective layer as a metal oxide particle.

The protective layer favorably includes two types of metal oxides. The two types of metal oxides are favorably a first metal oxide having conductivity and a second metal oxide having conductivity lower (in other words, volume resistivity higher) than that of the first metal oxide.

The first metal oxide is favorably phosphorus-doped tin oxide or antimony-doped tin oxide, and the second metal oxide is favorably alumina. That is, one of the two types of metal oxides included in the protective layer is favorably alumina. The other of the two types of metal oxides is favorably phosphorus-doped tin oxide or antimony-doped tin oxide. A ratio M2/M1 of a mass M2 of the phosphorus-doped tin oxide or antimony-doped tin oxide to a mass M1 of the alumina is favorably 1 or more and 10 or less, more favorably 1 or more and 5 or less, and still more favorably 1 or more and 3 or less.

The BET specific surface area of the metal oxide particle is favorably 30 m²/g or more and 200 m²/g or less, more favorably 55 m²/g or more and 130 m²/g or less. The number average primary particle size of the metal oxide particle is favorably 5 nm or more and 50 nm or less, more favorably 20 nm or more and 35 nm or less.

The content ratio of the metal oxide occupied in the protective layer is favorably 1 mass % or more and 20 mass % or less, more favorably 10 mass % or more and 15 mass % or less, with respect to the mass of the protective layer.

### (Polymerization Initiator)

The polymerization initiator is, for example, a photopolymerization initiator. Examples of the photopolymerization initiator include an acylphosphine oxide compound, an acetophenone compound, a ketal compound, a benzoinether compound, an anthraquinone compound, and a thioxanthone compound. An acylphosphine oxide compound is favorable as a photopolymerization initiator because it has high ultraviolet absorption efficiency. Examples of the acylphosphine oxide compound include 2,4,6-trimethylbenzoyl-diphenylphosphineoxide, phenylbis(2,4,6-trimethylbenzoyl)phosphineoxide, and lithiumphenyl(2,4,6-trimethylbenzoyl)phosphonate. The content ratio of the polymerization initiator occupied in the protective layer is favorably 1 mass % or more and 20 mass % or less, more favorably 5 mass % or more and 10 mass % or less, with respect to the mass of the protective layer.

### (Additive)

Examples of the additive included in the protective layer include a leveling agent (e.g., silicone oil and a leveling agent containing a halogen atom) and silica. As the leveling agent, a leveling agent containing a halogen atom is favorable, an acrylic polymer containing a halogen atom is more favorable, a fluorosilicone modified acrylic polymer is still more favorable, and a UV curable fluorosilicone modified acrylic polymer is particularly favorable. The leveling agent favorable has a polymerizable functional group. In the case where the leveling agent has a polymerizable functional group, the photocurable resin includes a repeating unit derived from a leveling agent as a repeating unit. In the case where the leveling agent has a polymerizable functional group, the polymerizable functional group equivalent (e.g., the vinyl group equivalent) of the leveling agent is favorably 100 g/mol or more and 500 g/mol or less, more favorably 260 g/mol or more and 450 g/mol or less. Note that it is favorable that the protective layer does not include a charge generating agent, a hole transporting agent, and an electron transporting agent.

### <Photosensitive Layer>

The photosensitive layer includes a charge generating agent, a hole transporting agent, and a binder resin. In the case where the photoreceptor is a single-layer photoreceptor, a single-layer photosensitive layer that is a photosensitive layer includes a charge generating agent, a hole transporting agent, and a binder resin. The single-layer photosensitive layer favorably further includes an electron transporting agent. The single-layer photosensitive layer may further include an additive, as necessary.

In the case where the photoreceptor is a stacked photoreceptor, the charge generating layer included in the photosensitive layer includes a charge generating agent. The charge transporting layer included in the photosensitive layer includes a hole transporting agent and a binder resin. The charge generating layer may further include a base resin, as necessary. Each of the charge generating layer and the charge transporting layer may further include an additive, as necessary. Each of the charge generating layer and the charge transporting layer may include a radical acceptor compound. However, each of the charge generating layer and the charge transporting layer does not necessarily need to include a radical acceptor compound, because the photoreceptor according to the first embodiment is capable of suppressing decomposition of the hole transporting agent even if it does not include a radical acceptor compound.

### (Charge Generating Agent)

Examples of the charge generating agent include a phthalocyanine pigment, a perylene pigment, a bisazo pigment, a trisazo pigment, a dithioketopyrrolopyrrole pigment, a metal-free naphthalocyanine pigment, a metal naphthalocyanine pigment, a squaraine pigment, an indigo pigment, an azulenium pigment, a cyanine pigment, a powder of inorganic photoconductive materials (e.g., selenium, selenium-tellurium, selenium-arsenic, cadmium sulfide, and amorphous silicon), a pyrylium pigment, an anthanthron pigment, a triphenylmethane pigment, a threne pigment, a toluidine pigment, a pyrazoline pigment, and a quinacridone pigment.

The phthalocyanine pigment has a phthalocyanine structure. Examples of the phthalocyanine pigment include metal phthalocyanine and metal-free phthalocyanine. Examples of the metal phthalocyanine include titanyl phthalocyanine, hydroxygallium phthalocyanine, and chlorogallium phthalocyanine. As the metal phthalocyanine, titanyl phthalocyanine is favorable. The titanyl phthalocyanine is represented by the formula (CG-1). The metal-free phthalocyanine is represented by the formula (CG-2).

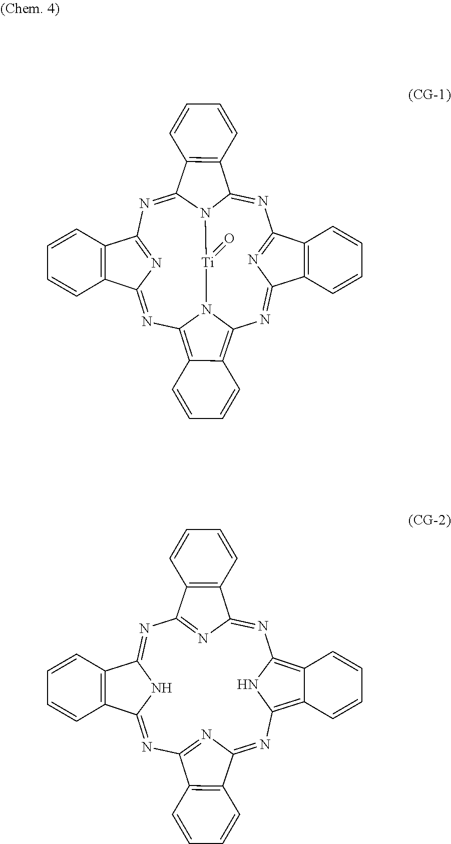

The phthalocyanine pigment may be crystalline or non-crystalline. Examples of the crystal of the metal-free phthalocyanine include an X-type crystal of the metal-free phthalocyanine (hereinafter, referred to as an X-type metal-free phthalocyanine in some cases). Examples of the crystal of the titanyl phthalocyanine include α-type, β-type, and Y-type crystals of the titanyl phthalocyanine (hereinafter, respectively referred to as α-type, β-type, and Y-type titanyl phthalocyanines in some cases).

For example, for a digital optical image forming apparatus (e.g., a laser beam printer or a facsimile machine using a light source such as semiconductor laser light), it is favorable to use a photoreceptor having sensitivity in a wavelength region of 700 nm or more. As the charge generating agent, a phthalocyanine pigment is favorable, titanyl phthalocyanine or metal-free phthalocyanine is more favorable, and Y-type titanyl phthalocyanine or X-type metal-free phthalocyanine is particularly favorable because they have a high quantum yield in the wavelength region of 700 nm or more.

The Y-type titanyl phthalocyanine has a main peak at, for example, 27.2° of the Bragg angle (2θ+0.2°) in the CuKα characteristic X-ray diffraction spectrum. The main peak in the CuKα characteristic X-ray diffraction spectrum is a peak having the first or second highest intensity in the range of the Bragg angle (2θ+0.2°) of 3° or more and 400 or less. The Y-type titanyl phthalocyanine does not have a peak at 26.2° in the CuKα characteristic X-ray diffraction spectrum.

The CuKα characteristic X-ray diffraction spectrum can be measured by, for example, the following method. First, a sample holder of an X-ray diffractometer (e.g., “RINT (registered trademark) 1100” manufactured by Rigaku Holdings Corporation and its Global Subsidiaries) is filled with a sample (titanyl phthalocyanine) to measure the X-ray diffraction spectrum under the conditions of an X-ray tube Cu, a tube voltage of 40 kV, a tube current of 30 mA, and a wavelength of CuKα characteristic X-rays of 1.542 Å. The measurement range (2θ) is, for example, 3° or more and 400 or less (start angle of 3°, stop angle of 40°), and the scanning speed is, for example, 10°/min. The main peak is determined from the obtained X-ray diffraction spectrum, and the Bragg angle of the main peak is read.

In the case where the photoreceptor is a single-layer photoreceptor, the content of the charge generating agent in the single-layer photosensitive layer that is a photosensitive layer is favorably 0.1 parts by mass or more and 50 parts by mass or less, more favorably 0.5 parts by mass or more and 30 parts by mass or less with respect to 100 parts by mass of the binder resin. In the case where the photoreceptor is a stacked photoreceptor, the content of the charge generating agent in the photosensitive layer (specifically, the charge generating layer) is favorably 10 parts by mass or more and 300 parts by mass or less, more favorably 100 parts by mass or more and 200 parts by mass or less with respect to 100 parts by mass of the base resin.

### (Hole Transporting Agent)

The hole transporting agent has two or less (one or two) predetermined double bonds or no predetermined double bond. The predetermined double bond is a bond represented by the following formula (DB). In the formula (DB), * represents atomic bonding. The predetermined double bond is an unsubstituted ethene-1,2-diyl group. The predetermined double bond (i.e., chain ethene-1,2-diyl group) is a double bond forming a chain group because it is chain. The predetermined double bond is not a double bond forming a ring such as a benzene ring because it is chain.

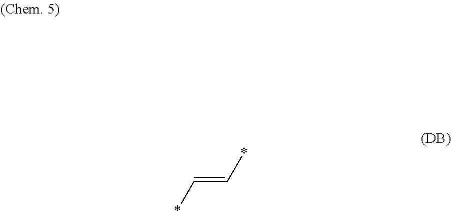 [SMILES: */C=C/*]

The hole transporting agent favorably includes at least one of compounds represented by the formulae (1), (2), and (3). Hereinafter, the compounds represented by the formulae (1), (2), and (3) will be respectively referred to as hole transporting agents (1), (2), and (3) in some cases.

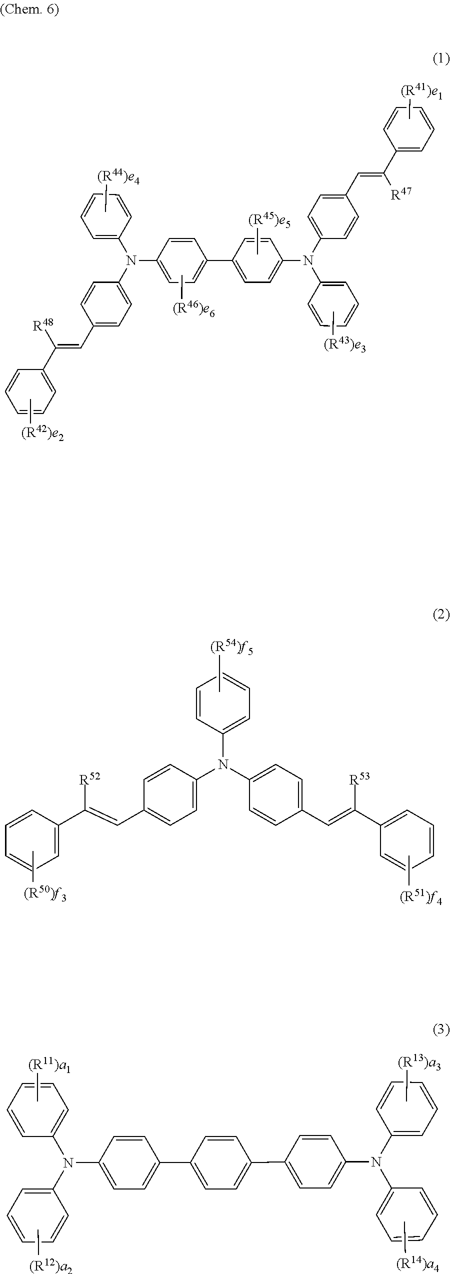

In the formula (1), R⁴¹, R⁴², R⁴³, R⁴⁴, R⁴⁵, and R⁴⁶ each independently represent an alkyl group having 1 or more and 8 or less carbon atoms or a phenyl group. R⁴⁷ and R⁴⁸ each independently represent a hydrogen atom, an alkyl group having 1 or more and 8 or less carbon atoms, or a phenyl group. e₁, e₂, e₃, and e₄ each independently represent an integer of 0 or more and 5 or less. e₅ and e₆ each independently represent an integer of 0 or more and 4 or less.

In the formula (1), when e₁ represents an integer of 2 or more and 5 or less, a plurality of R⁴¹ may represent the same group or different groups. When e₂ represents an integer of 2 or more and 5 or less, a plurality of R⁴² may represent the same group or different groups. When e₃ represents an integer of 2 or more and 5 or less, a plurality of R⁴³ may represent the same group or different groups. When e₄ represents an integer of 2 or more and 5 or less, a plurality of R⁴⁴ may represent the same group or different groups. When e₅ represents an integer of 2 or more and 4 or less, a plurality of R⁴⁵ may represent the same group or different groups. When e₆ represents an integer of 2 or more and 4 or less, a plurality of R⁴⁶ may represent the same group or different groups.

In the formula (1), R⁴¹ to R⁴⁶ each independently represent favorably an alkyl group having 1 or more and 8 or less carbon atoms, more favorably an alkyl group having 1 or more and 3 or less carbon atoms, and still more favorably a methyl group or an ethyl group. R⁴⁷ and R⁴⁸ favorably each represent a hydrogen atom. It is favorable that e₁, e₂, e₃, and e₄ each independently represent an integer of 0 or more and 2 or less, and it is more favorable that e₁ and e₂ each represent 0 and e₃ and e₄ each represent 2. e₅ and e₆ favorably each represent 0.

In the formula (2), R⁵⁰, R⁵¹, and R⁵⁴ each independently represent an alkyl group having 1 or more and 8 or less carbon atoms or a phenyl group. R⁵² and R⁵³ each independently represent a hydrogen atom, an alkyl group having 1 or more and 8 or less carbon atoms, or a phenyl group that may be substituted with an alkyl group having 1 or more and 8 or less carbon atoms. f₃, f₄, and f₅ each independently represent an integer of 0 or more and 5 or less.

In the formula (2), when f₃ represents an integer of 2 or more and 5 or less, a plurality of R⁵⁰ may represent the same group or different groups. When f₄ represents an integer of 2 or more and 5 or less, a plurality of R⁵¹ may represent the same group or different groups. When f₅ represents an integer of 2 or more and 5 or less, a plurality of R⁵⁴ may represent the same group or different groups.

In the formula (2), R⁵⁰, R⁵¹, and R⁵⁴ each independently represent favorably an alkyl group having 1 or more and 8 or less carbon atoms, more favorably an alkyl group having 1 or more and 3 or less carbon atoms, and still more favorably a methyl group. R⁵² and R⁵³ favorably each independently represent a hydrogen atom, an unsubstituted phenyl group, or a phenyl group substituted with an alkyl group having 1 or more and 8 or less carbon atoms. In the case where a phenyl group is substituted with an alkyl group having 1 or more and 8 or less carbon atoms, as such an alkyl group having 1 or more and 8 or less carbon atoms, an alkyl group having 1 or more and 3 or less carbon atoms is favorable and a methyl group is more favorable. f₃, f₄, and f₅ favorably each independently represent 0 or 1.

In the formula (3), R¹¹, R¹², R¹³, and R¹⁴ each independently represent an alkyl group having 1 or more and 8 or less carbon atoms or a phenyl group. a₁, a₂, a₃, and a₄ each independently represent an integer of 0 or more and 5 or less.

In the formula (3), when a₁ represents an integer of 2 or more and 5 or less, a plurality of R¹¹ may represent the same group or different groups. When a₂ represents an integer of 2 or more and 5 or less, a plurality of R¹² may represent the same group or different groups. When a₃ represents an integer of 2 or more and 5 or less, a plurality of R¹³ may represent the same group or different groups. When a₄ represents an integer of 2 or more and 5 or less, a plurality of R¹⁴ may represent the same group or different groups.

In the formula (3), R¹¹, R¹², R¹³, and R¹⁴ each independently represent favorably an alkyl group having 1 or more and 3 or less carbon atoms, more favorably a methyl group or an ethyl group. a₁, a₂, a₃, and a₄ each independently represent favorably an integer of 1 or more and 3 or less, more favorably 1.

Suitable examples of the hole transporting agent include compounds represented by the formulae (HT-2), (HT-3), and (HT-4) (hereinafter, respectively referred to as hole transporting agents (HT-2), (HT-3), and (HT-4) in some cases). The numbers of predetermined double bonds in the hole transporting agents (HT-2), (HT-3), and (HT-4) are 2, 0, and 0, respectively.

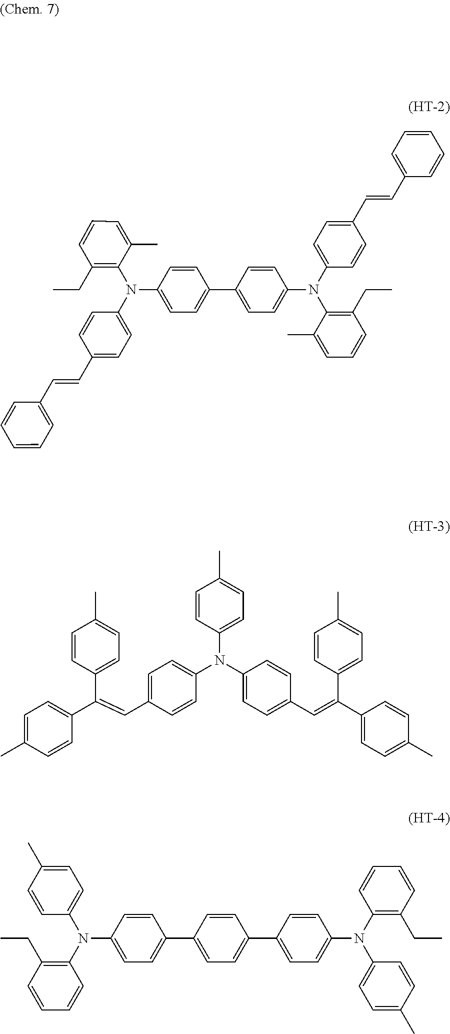

The photosensitive layer may further include a hole transporting agent having three or more predetermined double bonds (hereinafter, referred to as a different hole transporting agent in some cases). However, in order to suitably suppress decomposition of the hole transporting agent due to ultraviolet irradiation in the protective layer forming step, it is favorable that the photosensitive layer does not include the different hole transporting agent. The content ratio of the hole transporting agent having two or less predetermined double bonds or no predetermined double bond occupied in all hole transporting agents in the photosensitive layer is favorably 80 mass % or more, more favorably 90 mass % or more, and still more favorably 100 mass % with respect to the total mass of the hole transporting agents.

In the case where the photoreceptor is a single-layer photoreceptor, the content of the hole transporting agent in the single-layer photosensitive layer that is a photosensitive layer is favorably 10 parts by mass or more and 200 parts by mass or less, more favorably 80 parts by mass or more and 130 parts by mass or less, with respect to 100 parts by mass of the binder resin. In the case where the photoreceptor is a stacked photoreceptor, the content of the hole transporting agent in the photosensitive layer (specifically, the charge transporting layer) is favorably 10 parts by mass or more and 200 parts by mass or less, more favorably 50 parts by mass or more and 100 parts by mass or less, with respect to 100 parts by mass of the binder resin.

### (Electron Transporting Agent)

Examples of the electron transporting agent include a quinone compound, a diimide compound, a hydrazone compound, a malononitrile compound, a thiopyran compound, a trinitrothioxanthone compound, a 3,4,5,7-tetranitro-9-fluorenone compound, a dinitroanthracene compound, a dinitroacridine compound, tetracyanoethylene, 2,4,8-trinitrothioxanthone, dinitrobenzene, dinitroacridine, succinic anhydride, maleic anhydride, and dibromomaleic anhydride. Examples of the quinone compound include a diphenoquinone compound, an azoquinone compound, an anthraquinone compound, a naphthoquinone compound, a nitroanthraquinone compound, and a dinitroanthraquinone compound.

The electron transporting agent favorably includes at least one of compounds represented by the formulae (11), (12), (13), (14), (15), and (16). Hereinafter, the compounds represented by the formulae (11), (12), (13), (14), (15), and (16) will be respectively referred to as electron transporting agents (11), (12), (13), (14), (15), and (16) in some cases.

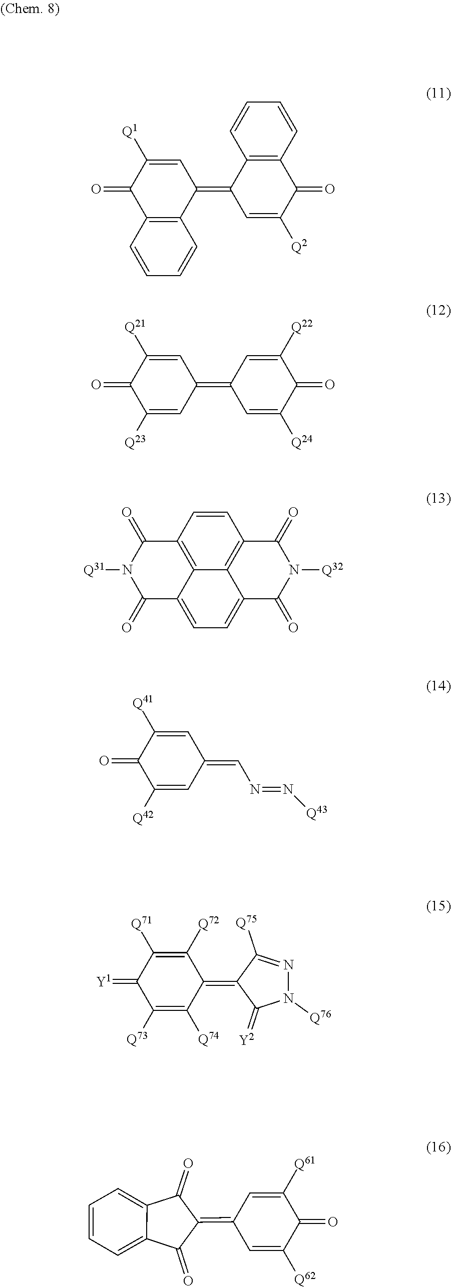

Q¹ and Q² in the formula (11), Q²¹, Q²², Q²³, and Q²⁴ in the formula (12), Q³¹ and Q³² in the formula (13), Q⁴¹, Q⁴², and Q⁴³ in the formula (14), Q⁷¹, Q⁷², Q⁷³, Q⁷⁴, Q⁷⁵, and Q⁷⁶ in the formula (15), and Q⁶¹ and Q⁶² in the formula (16) each independently represent a hydrogen atom, a halogen atom, a cyano group, an alkyl group having 1 or more and 6 or less carbon atoms, an alkenyl group having 2 or more and 6 or less carbon atoms, an alkoxy group having 1 or more and 6 or less carbon atoms, or an aryl group having 6 or more and 14 or less carbon atoms, which may be substituted with at least one substituent group selected from the group consisting of an alkyl group having 1 or more and 6 or less carbon atoms and a halogen atom. Y¹ and Y² in the formula (15) each represent an oxygen atom.

Q¹ and Q² in the formula (11), Q²¹, Q²², Q²³, and Q²⁴ in the formula (12), Q³¹ and Q³² in the formula (13), Q⁴¹, Q⁴², and Q⁴³ in the formula (14), Q⁷¹, Q⁷², Q⁷³, Q⁷⁴, Q⁷⁵, and Q⁷⁶ in the formula (15), and Q⁶¹ and Q⁶² in the formula (16) favorably each independently represent a hydrogen atom, an alkyl group having 1 or more and 6 or less carbon atoms, or an aryl group having 6 or more and 14 or less carbon atoms, which may be substituted with at least one substituent group selected from the group consisting of an alkyl group having 1 or more and 6 or less carbon atoms and a halogen atom.

As the alkyl group having 1 or more and 6 or less carbon atoms represented by Q¹ and Q² in the formula (11), Q²¹, Q²², Q²³, and Q²⁴ in the formula (12), Q³¹ and Q³² in the formula (13), Q⁴¹, Q⁴², and Q⁴³ in the formula (14), Q⁷¹, Q⁷², Q⁷³, Q⁷⁴, Q⁷⁵, and Q⁷⁶ in the formula (15), and Q⁶¹ and Q⁶² in the formula (16), an alkyl group having 1 or more and 5 or less carbon atoms is favorable, a methyl group, an ethyl group, a propyl group, a butyl group, or a pentyl group is favorable, and a methyl group, a tert-butyl group, or a 1,1-dimethylpropyl group is particularly favorable.

As the aryl group having 6 or more and 14 or less carbon atoms represented by Q¹ and Q² in the formula (11), Q²¹, Q²², Q²³, and Q²⁴ in the formula (12), Q³¹ and Q³² in the formula (13), Q⁴¹, Q⁴², and Q⁴³ in the formula (14), Q⁷¹, Q⁷², Q⁷³, Q⁷⁴, Q⁷⁵, and Q⁷⁶ in the formula (15), and Q⁶¹ and Q⁶² in the formula (16), an aryl group having 6 or more and 10 or less carbon atoms is favorable and a phenyl group is more favorable. The aryl group having 6 or more and 14 or less carbon atoms may be substituted with at least one substituent group selected from the group consisting of an alkyl group having 1 or more and 6 or less carbon atoms and a halogen atom. As such an alkyl group having 1 or more and 6 or less carbon atoms, an alkyl group having 1 or more and 3 or less carbon atoms is favorable and a methyl group or an ethyl group is more favorable. As the halogen atom that is a substituent group, a fluorine atom, a chlorine atom, or a bromine atom is favorable and a chlorine atom is particularly favorable. In the case where the aryl group having 6 or more and 14 or less carbon atoms is substituted with a substituent group, the number of substituent groups is favorably 1 or more and 5 or less, more favorably 1 or 2. As the aryl group having 6 or more and 14 or less carbon atoms substituted with at least one substituent group selected from the group consisting of an alkyl group having 1 or more and 6 or less carbon atoms and a halogen atom, a chlorophenyl group, a dichlorophenyl group, or an ethylmethylphenyl group is favorable and a 4-chlorophenyl group, a 2,5-dichlorophenyl group, or a 2-ethyl-6-methylphenyl group is more favorable.

Suitable examples of the electron transporting agent include compounds represented by the formulae (ET-1) to (ET-7) (hereinafter, respectively referred to as electron transporting agents (ET-1) to (ET-7) in some cases).

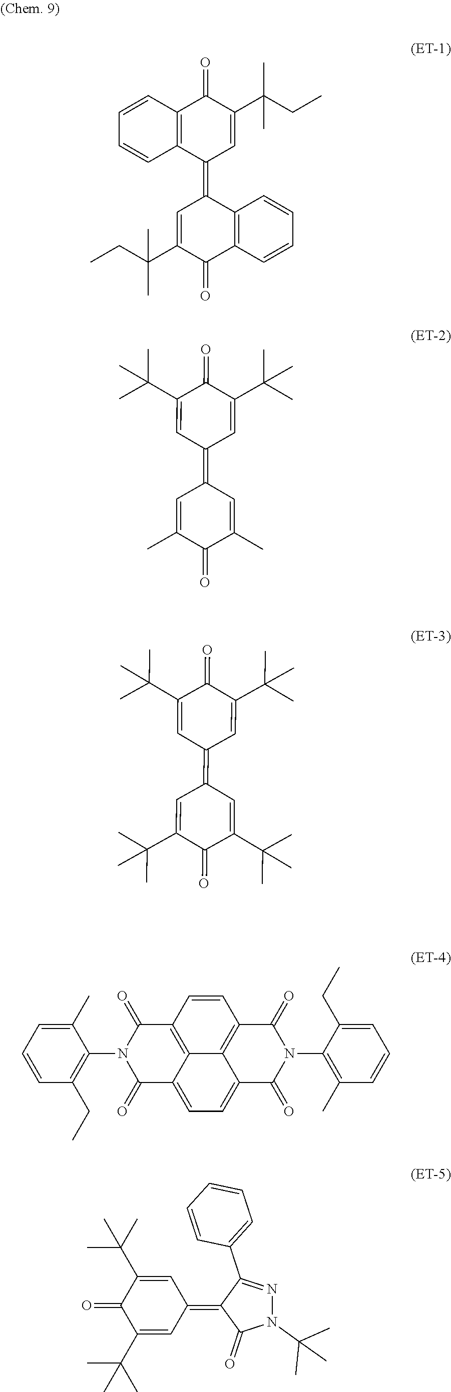

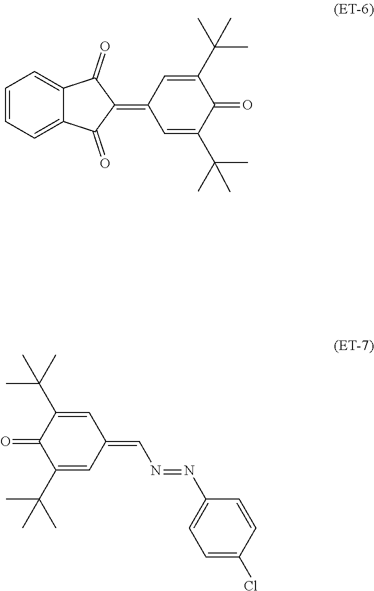

The content ratio of the electron transporting agents (11) to (16) occupied in all electron transporting agents in the photosensitive layer is favorably 80 mass % or more, more favorably 90 mass % or more, and still more favorably 100 mass % with respect to the total mass of the electron transporting agents in the photosensitive layer. In the case where the photoreceptor is a single-layer photoreceptor, the content of the electron transporting agent in the single-layer photosensitive layer that is a photosensitive layer is favorably 5 parts by mass or more and 150 parts by mass or less, more favorably 10 parts by mass or more and 50 parts by mass or less, with respect to 100 parts by mass of the binder resin.

### (Binder Resin)

Examples of the binder resin include a thermoplastic resin (more specifically, a polyarylate resin, a polycarbonate resin, a styrene resin, a styrene-butadiene copolymer, a styrene-acrylonitrile copolymer, a styrene-maleic acid copolymer, a styrene-acrylic acid copolymer, an acrylic copolymer, a polyethylene resin, an ethylene-vinyl acetate copolymer, a chlorinated polyethylene resin, a polyvinyl chloride resin, a polypropylene resin, an ionomer, a vinyl chloride-vinyl acetate copolymer, a polyester resin, an alkyd resin, a polyamide resin, a polyurethane resin, a polysulfone resin, a diallylphthalate resin, a ketone resin, a polyvinylbutyral resin, a polyvinylacetal resin, and a polyether resin), a thermosetting resin (more specifically, a silicone resin, an epoxy resin, a phenolic resin, a urea resin, a melamine resin, and a cross-linkable thermosetting resin other than these), and a photocurable resin (more specifically, an epoxy-acrylic acid resin, and a urethane-acrylic acid copolymer).

Of these resins, a polycarbonate resin is favorable because a single-layer photosensitive layer and a charge transporting layer having an excellent balance of workability, mechanical strength, optical characteristics, and wear resistance can be obtained. Examples of the polycarbonate resin include a bisphenol Z-type polycarbonate resin, a bisphenol B-type polycarbonate resin, a bisphenol ZC-type polycarbonate resin, a bisphenol C-type polycarbonate resin, and a bisphenol A-type polycarbonate resin. As the binder resin, a bisphenol Z-type polycarbonate resin or a bisphenol B-type polycarbonate resin is favorable. The bisphenol Z-type polycarbonate resin is a resin including a repeating unit represented by the formula (BisZ). The bisphenol B-type polycarbonate resin is a resin including a repeating unit represented by the formula (BisB).

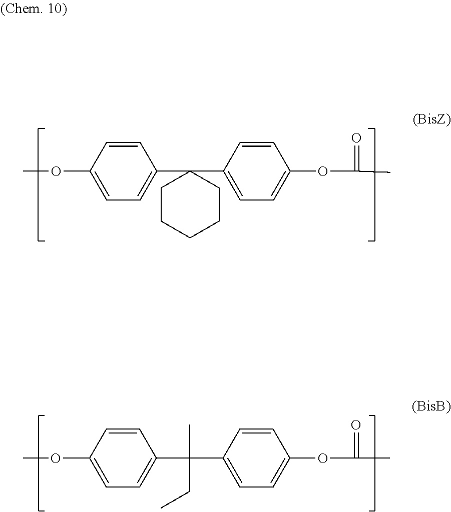

### (Base Resin)

Examples of the base resin included in the charge generating layer are the same as the examples of the binder resin included in the charge transporting layer. However, in order to suitably form a charge generating layer and a charge transporting layer, it is favorable to select, as a base resin, a resin different from the resin used as the binder resin, of the above examples of the binder resin. The base resin is, for example, a polyvinylacetal resin.

### (Additive)

Examples of the additive included in the photosensitive layer include an ultraviolet absorber, an antioxidant, a radical scavenger, a singlet quencher, a softener, a surface modifier, a bulking agent, a thickener, a dispersion stabilizer, a wax, a donor, a surfactant, a plasticizer, a sensitizer, an electron acceptor compound, and a leveling agent. Examples of the leveling agent include silicone oil, more specifically, dimethylsilicone oil.

### <Intermediate Layer>

The presence of the intermediate layer makes the flow of currents generated when the photoreceptor is exposed smooth and makes it possible to suppress an increase in resistance, while maintaining the insulated state to the extent that leakage can be suppressed. The intermediate layer (undercoat layer) includes, for example, one or both of an inorganic particle and an organic particle, and a resin used for the intermediate layer (hereinafter, referred to as an “intermediate layer resin” in some cases). Hereinafter, the inorganic particle and the organic particle included in the intermediate layer will be collectively referred to as an intermediate layer particle. The ratio of the mass of the intermediate layer particle to the mass of the intermediate layer resin is, for example, 1 or more and 4 or less. The thickness of the intermediate layer is, for example, 0.1 μm or more and 5 μm or less.

Examples of the inorganic particle of the intermediate layer particle include a white pigment (more specifically, titanium oxide, zinc oxide, zinc flower, zinc sulfide, white lead, lithopone, and the like), and an extender pigment (more specifically, alumina, calcium carbonate, barium sulfate, and the like). Examples of the organic particle of the intermediate layer particle include a fluoropolymer particle, a benzoguanamine resin particle, and a styrene resin particle. The number average primary particle size of the intermediate layer particle is favorably 100 nm or less, more favorably 1 nm or more and 50 nm or less. As the intermediate layer particle, an inorganic particle is favorable and titanium oxide is more favorable. Titanium oxide may be subjected to surface treatment. The surface treatment of titanium oxide may be performed once or a plurality of times (e.g., twice). Examples of the surface treatment agent used for the surface treatment of titanium oxide include alumina, silica, and an organosilicon compound (e.g., polysiloxane, more specifically, methylhydrogenpolysiloxane).

Examples of the intermediate layer resin are the same as the examples of the binder resin included in the photosensitive layer. However, in order to suitably form a photosensitive layer, it is favorable to select, as an intermediate layer resin, a resin different from the resin used as the binder resin, of the above examples of the binder resin. The intermediate layer resin is, for example, a polyamide resin.

### <Conductive Substrate>

The conductive substrate is not particularly limited, and at least the surface portion thereof only needs to be formed of a material having conductivity. One example of the conductive substrate is a conductive substrate formed of a material having conductivity. Another example of the conductive substrate is a conductive substrate covered with a material having conductivity. Examples of the material having conductivity include aluminum, iron, copper, tin, platinum, silver, vanadium, molybdenum, chromium, cadmium, titanium, nickel, palladium, and indium. Two or more materials having conductivity may be combined and used as an alloy (more specifically, an aluminum alloy, stainless steel, brass, or the like). As the material having conductivity, aluminum and an aluminum alloy are favorable because they provide good charge transfer from the photosensitive layer to the conductive substrate. The shape of the conductive substrate is appropriately selected in accordance with the structure of the image forming apparatus. Examples of the shape of the conductive substrate include a sheet shape and a drum shape. Further, the thickness of the conductive substrate is appropriately selected in accordance with the shape of the conductive substrate.

### Second Embodiment: Method of Producing Photoreceptor

Next, an example of a method of producing a photoreceptor according to a second embodiment of the present invention will be described. The method of producing a photoreceptor according to the second embodiment includes, for example, a photosensitive layer forming step and a protective layer forming step.

### (Step of Forming Photosensitive Layer of Single-Layer Photoreceptor)

A photosensitive layer forming step in the case where the photoreceptor is a single-layer photoreceptor will be described. The step of forming a photosensitive layer of a single-layer photoreceptor includes a single-layer photosensitive layer forming step. In the single-layer photosensitive layer forming step, a coating liquid for forming a single-layer photosensitive layer (hereinafter, referred to as a coating liquid for a single-layer photosensitive layer in some cases) is prepared. The coating liquid for a single-layer photosensitive layer includes, for example, a charge generating agent, a hole transporting agent, a binder resin, a solvent, an electron transporting agent as necessary, and an additive as necessary. The coating liquid for a single-layer photosensitive layer is prepared by mixing these. Subsequently, the coating liquid for a single-layer photosensitive layer is applied onto the conductive substrate. Subsequently, at least part of the solvent included in the applied coating liquid for a photosensitive layer is removed to form a single-layer photosensitive layer.

### (Step of Forming Photosensitive Layer of Stacked Photoreceptor)

A photosensitive layer forming step in the case where the photoreceptor is a stacked photoreceptor will be described. The step of forming a photosensitive layer of a stacked photoreceptor includes a charge generating layer forming step and a charge transporting layer forming step.

In the charge generating layer forming step, a coating liquid for forming a charge generating layer (hereinafter, referred to as a coating liquid for a charge generating layer in some cases) is prepared. The coating liquid for a charge generating layer includes, for example, a charge generating agent, a base resin, a solvent, and additive as necessary. The coating liquid for a charge generating layer is prepared by mixing these. Subsequently, the coating liquid for a charge generating layer is applied onto the conductive substrate. Subsequently, at least part of the solvent included in the applied coating liquid for a charge generating layer is removed to form a charge generating layer.

In the charge transporting layer forming step, a coating liquid for forming a charge transporting layer (hereinafter, referred to as a coating liquid for a charge transporting layer in some cases) is prepared. The coating liquid for a charge transporting layer includes a hole transporting agent, a binder resin, a solvent, and an additive as necessary. The coating liquid for a charge transporting layer is prepared by mixing these. Subsequently, the coating liquid for a charge transporting layer is applied onto the charge generating layer. Subsequently, at least part of the solvent included in the applied coating liquid for a charge transporting layer is removed to form a charge transporting layer.

### (Protective Layer Forming Step)

In the protective layer forming step, a protective layer including a photocurable resin is formed on the photosensitive layer. First, a coating liquid for forming a protective layer (hereinafter, referred to as a coating liquid for a protective layer in some cases) is prepared. The coating liquid for a protective layer includes at least one of the monomer and the like for forming a photocurable resin, a polymerization initiator, a solvent, a metal oxide as necessary, and an additive as necessary. The coating liquid for a protective layer is prepared by mixing these. Subsequently, the coating liquid for a protective layer is applied onto the photosensitive layer. Subsequently, ultraviolet rays are applied to the coating liquid for a protective layer (more specifically, at least one of the monomer and the like included in the coating liquid for a protective layer) on the photosensitive layer to polymerize the at least one of the monomer and the like. The polymerization forms a photocurable resin that is a polymerized product.

The ultraviolet rays to be applied in the protective layer forming step are applied from, for example, a light-emitting diode light source. In order to suitably progress the photocuring reaction, the wavelength of the ultraviolet rays to be applied in the protective layer forming step is favorably 200 nm or more and 420 nm or less, more favorably 270 nm or more and 420 nm or less, and more favorably 365 nm. The light energy of the ultraviolet rays to be applied in the protective layer forming step is favorably 10000 mW·s or more and 100000 mW·s or less, more favorably 60300 mW·s or more and 86400 mW·s or less. When the light energy of ultraviolet rays is 10000 mW·s or more, the photocuring reaction progresses sufficiently and the protective layer can be sufficiently cured. When the light energy is 100000 mW·s or less, it is possible to further suppress decomposition of the hole transporting agent included in the photosensitive layer and improve the potential stability of the photoreceptor. In order to improve the potential stability of the photoreceptor, the light energy of ultraviolet rays is favorably set to a value that will make a residual ratio Z of the hole transporting agent described below 80% or more.

When the residual ratio of the hole transporting agent is defined represented by Z, the residual ratio of the hole transporting agent (hereinafter, referred to as a “residual ratio Z of the hole transporting agent” in some cases) is favorably 80% or more. The residual ratio Z of the hole transporting agent is calculated by a calculation formula (I).

$$Z = 100 \times ( A 2 / A 1 ) \qquad ( I )$$

In the formula (I), A1 represents absorbance of the hole transporting agent at a predetermined wavelength before irradiation of predetermined ultraviolet rays (hereinafter, referred to as “absorbance A1” in some cases.). A2 represents absorbance of the hole transporting agent at the predetermined wavelength after irradiation of the predetermined ultraviolet rays (hereinafter, referred to as “absorbance A2” in some cases.). In the present specification, the predetermined ultraviolet rays are defined as ultraviolet rays having the same wavelength and the same light energy as those of the ultraviolet rays to be applied in the protective layer forming step. In the present specification, the predetermined wavelength is defined as the same wavelength as the wavelength of the predetermined ultraviolet rays. Therefore, the wavelength of the ultraviolet rays to be applied in the protective layer forming step, the wavelength of the predetermined ultraviolet rays applied in measurement of the residual ratio Z of the hole transporting agent, and the predetermined wavelength have the same value.

At least part of the ultraviolet rays applied to the coating liquid for a protective layer in the protective layer forming step passes through the coating liquid for a protective layer and reaches the photosensitive layer. The hole transporting agent having the residual ratio Z of 80% or more is difficult to decompose due to the ultraviolet rays applied in the protective layer forming step. When the photosensitive layer includes the hole transporting agent having the residual ratio Z of 80% or more, it is possible to suppress decomposition of the hole transporting agent due to ultraviolet rays and improve the potential stability of the photoreceptor. Therefore, it is favorable to use a hole transporting agent having the residual ratio Z of 80% or more as the hole transporting agent to be included in the photosensitive layer.

In order to suppress decomposition of the hole transporting agent and improve the potential stability of the photoreceptor, the residual ratio Z of the hole transporting agent is favorably 85% or more, more favorably 90% or more. The residual ratio Z of the hole transporting agent is, for example, 100% or less.

Hereinafter, a method of measuring the residual ratio Z of the hole transporting agent will be described with reference to FIG. 7. FIG. 7 shows an absorption spectrum of a hole transporting agent (HT-3) included in a photosensitive layer included in a photoreceptor according to Example 4 described below before and after predetermined ultraviolet irradiation. This absorption spectrum is measured by ultraviolet-visible spectroscopy. In FIG. 7, the horizontal axis indicates the wavelength (unit: nm) and the vertical axis represents the absorbance. In the measurement of the residual ratio Z of the hole transporting agent, first, a measurement sample that includes 25 parts by mass of a hole transporting agent and 100 parts by mass of a binder resin and has a thickness of 3 μm is prepared. The ultraviolet-visible light absorption spectrum of the measurement sample before and after irradiation of the predetermined ultraviolet rays is measured using an ultraviolet-visible spectrophotometer. Note that in the example shown in FIG. 7, the wavelength of the predetermined ultraviolet rays is set to 365 nm. The absorbance A1 at a predetermined wavelength W (i.e., the same wavelength as the wavelength of the predetermined ultraviolet rays, 365 nm in the example shown in FIG. 7) is obtained from the ultraviolet-visible light absorption spectrum (spectrum indicated by a solid line in FIG. 7) measured before applying the predetermined ultraviolet rays. The absorbance A2 at the predetermined wavelength W is obtained from the ultraviolet-visible light absorption spectrum (spectrum indicated by a broken line in FIG. 7) measured after applying the predetermined ultraviolet rays. Then, the residual ratio Z of the hole transporting agent is calculated from the absorbance A1 and the absorbance A2 in accordance with the calculation formula (I). Details of the residual ratio Z of the hole transporting agent will be described below in Examples.

The photosensitive layer forming step and the protective layer forming step have been described above. The method of producing a photoreceptor according to the second embodiment will be further described below.

The solvent included in the above coating liquid for a single-layer photosensitive layer, coating liquid for a charge generating layer, and coating liquid for a charge transporting layer, and coating liquid for a protective layer (hereinafter, collectively referred to as a coating liquid in some cases) is not particularly limited as long as the components included in the coating liquid can be dissolved or dispersed. Examples of the solvent include an alcohol (more specifically, methanol, ethanol, isopropanol, butanol, and the like), an aliphatic hydrocarbon (more specifically, n-hexane, octane, cyclohexane, and the like), an aromatic hydrocarbon (more specifically, benzene, toluene, xylene, and the like), a halogenated hydrocarbon (more specifically, methylene chloride, chloroform, ethylene chloride, dichloromethane, dichloroethane, carbon tetrachloride, chlorobenzene, and the like), ether (more specifically, dioxane, dimethylether, diethylether, tetrahydrofuran, ethylene glycol dimethylether, propylene glycol monomethylether, diethylene glycol dimethyl ether, and the like), a ketone (more specifically, acetone, methyl ethyl ketone, 2-butanone, cyclohexanone, and the like), ester (more specifically, ethyl acetate, methyl acetate, and the like), dimethylformaldehyde, dimethylformamide, and dimethylsulfoxide.

The coating liquid is prepared by mixing the respective components and dissolving or dispersing them in a solvent. For mixing, for example, a bead mill, a ball mill, a roll mill, a paint shaker, or an ultrasonic disperser can be used.

The method of applying the coating liquid is not particularly limited as long as the coating liquid can be uniformly applied. Examples of the application method include a dip coating method, a spray coating method, a bead coating method, and a roller coating method.

Examples of the method of removing at least part of the solvent included in the above coating liquid for a single-layer photosensitive layer, coating liquid for a charge generating layer, and coating liquid for a charge transporting layer include heating, reduction of pressure, and a combination of heating and reduction of pressure. More specifically, a method of performing heat treatment (hot air drying) using a high-temperature dryer or a reduced-pressure dryer may be used. The temperature of heat treatment is, for example, 40° C. or more and 150° C. or less. The time of heat treatment is, for example, 3 minutes or more and 150 minutes or less.

The method of producing a photoreceptor according to the second embodiment may further include, as necessary, an intermediate layer forming step of forming an intermediate layer on the conductive substrate. Note that the intermediate layer forming step only needs to be performed by appropriately selecting a known method.

### Third Embodiment: Image Forming Apparatus

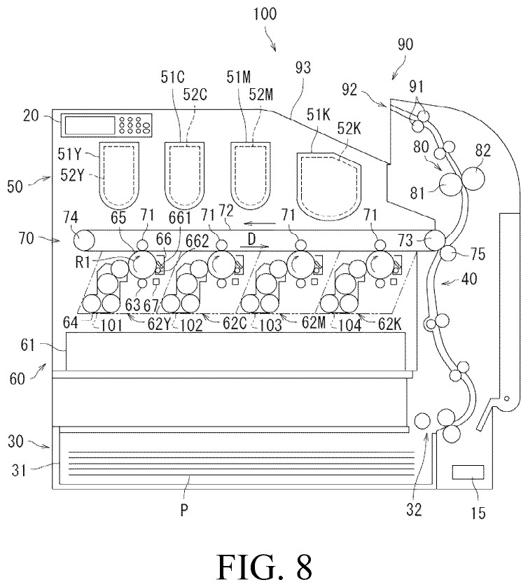

Next, an image forming apparatus 100 that is an example of an image forming apparatus according to a third embodiment of the present invention will be described with reference to FIG. 8. FIG. 8 is a diagram showing an example of a configuration of the image forming apparatus 100. The image forming apparatus 100 is, for example, a tandem-type color printer.

As shown in FIG. 8, the image forming apparatus 100 includes a control unit 15, an operation unit 20, a paper feed unit 30, a conveying unit 40, a toner supply unit 50, an image forming unit 60, a transfer device 70, a fixing device 80, and an output unit 90.

The control unit 15 controls the operation of the respective units of the image forming apparatus 100. The control unit 15 includes a processor (not shown) and a storage unit (not shown). The processor includes, for example, a central processing unit (CPU). The storage unit may include a memory such as a semiconductor memory and may include a hard disk drive (HDD). The processor executes a control program to control the operation of the image forming apparatus 100. The storage unit stores the control program.

The operation unit 20 accepts an instruction from a user. The operation unit 20 transmits, upon accepting an instruction from a user, a signal indicating the instruction from a user to the control unit 15. As a result, an image forming operation by the image forming apparatus 100 is started.

The paper feed unit 30 includes a paper feed cassette 31 and a paper feed roller group 32. The paper feed cassette 31 is capable of housing a plurality of recording media P (e.g., sheets of paper). The paper feed roller group 32 feeds the recording media P housed in the paper feed cassette 31 to the conveying unit 40 one sheet at a time.

The conveying unit 40 includes a roller and a guide member. The conveying unit 40 extends from the paper feed unit 30 to the output unit 90. The conveying unit 40 conveys the recording medium P from the paper feed unit 30 to the output unit 90 through the image forming unit 60 and the fixing device 80.

The toner supply unit 50 supplies a toner to the image forming unit 60. The toner supply unit 50 includes a first mounting portion 51Y, a second mounting portion 51C, a third mounting portion 51M, and a fourth mounting portion 51K.

A first toner container 52Y is mounted on the first mounting portion 51Y. Similarly, a second toner container 52C, a third toner container 52M, and fourth toner container 52K are respectively mounted on the second mounting portion 51C, the third mounting portion 51M, and the fourth mounting portion 51K.

A toner is housed in each of the first toner container 52Y, the second toner container 52C, the third toner container 52M, and the fourth toner container 52K. In the third embodiment, a yellow toner is housed in the first toner container 52Y. A cyan toner is housed in the second toner container 52C. A magenta toner is housed in the third toner container 52M. A black toner is housed in the fourth toner container 52K.

The image forming unit 60 includes an exposure device 61, a first image formation unit 62Y, a second image formation unit 62C, a third image formation unit 62M, and a fourth image formation unit 62K.

Each of the first image formation unit 62Y to the fourth image formation unit 62K includes a charging device 63, a development device 64, an image carrier 65, a cleaning device 66, and a static elimination device 67.

Note that regarding the configurations of the first image formation unit 62Y to the fourth image formation unit 62K, only the type of toner to be supplied from the toner supply unit 50 differs and the other configurations are the same. For this reason, in FIG. 8, the configuration of each of the second image formation unit 62C to the fourth image formation unit 62K is shown with the reference symbol omitted.

The image carrier 65 is the photoreceptor according to the first embodiment (more specifically, the single-layer photoreceptor 1 and the stacked photoreceptor 10). As described in the first embodiment, the photoreceptor according to the first embodiment is capable of sufficiently curing a protective layer even in the case where the protective layer includes a photocurable resin and has excellent potential stability. Therefore, the image forming apparatus 100 according to the third embodiment can include a photoreceptor that is capable of sufficiently curing a protective layer even in the case where the protective layer includes a photocurable resin and has excellent potential stability.

In the third embodiment, the image carrier 65 rotates in the direction indicated by an arrow R1 in FIG. 8 (clockwise direction in FIG. 8). The charging device 63, the development device 64, the cleaning device 66, and the static elimination device 67 are disposed along the circumferential surface of the image carrier 65 in the order described from the upstream side in the rotation direction of the image carrier 65.

The charging device 63 charges the surface (circumferential surface) of the image carrier 65. The charging device 63 uniformly charges the image carrier 65 to predetermined polarity by electric discharge. The charging device 63 is, for example, a charging roller.

The exposure device 61 exposes the charged surface of the image carrier 65. In detail, the exposure device 61 applies laser light to the charged surface of the image carrier 65. In this way, an electrostatic latent image is formed on the surface of the image carrier 65.

A toner is supplied from the toner supply unit 50 to the development device 64. The development device 64 supplies the toner supplied from the toner supply unit 50 to the surface of the image carrier 65. As a result, the electrostatic latent image formed on the surface of the image carrier 65 is developed as a toner image.

In the third embodiment, the development device 64 of the first image formation unit 62Y is connected to the first toner container 52Y. For this reason, a yellow toner is supplied to the development device 64 of the first image formation unit 62Y. Therefore, a yellow toner image is formed on the surface of the image carrier 65 of the first image formation unit 62Y.

Similarly, the development device 64 of the second image formation unit 62C, the development device 64 of the third image formation unit 62M, and the development device 64 of the fourth image formation unit 62K are respectively connected to the second toner container 52C, the third toner container 52M, and the fourth toner container 52K. For this reason, a cyan toner, a magenta toner, and a black toner are respectively supplied to the development device 64 of the second image formation unit 62C, the development device 64 of the third image formation unit 62M, and the development device 64 of the fourth image formation unit 62K. Therefore, a cyan toner image, a magenta toner image, and a black toner image are respectively formed on the surface of the image carrier 65 of the second image formation unit 62C, the surface of the image carrier 65 of the third image formation unit 62M, and the surface of the image carrier 65 of the fourth image formation unit 62K.

The cleaning device 66 includes a cleaning member 661 and a rubbing roller 662. After transfer by a primary transfer roller 71 described below, the cleaning member 661 is pressed against the surface of the image carrier 65 to collect the toner adhering to the surface of the image carrier 65. The cleaning member 661 is, for example, a cleaning blade. The rubbing roller 662 rubs the surface of the image carrier 65 to polish the surface of the image carrier 65.

The static elimination device 67 applies static elimination light to the surface of the image carrier 65 to eliminate static electricity on the surface of the image carrier 65.

The transfer device 70 transfers a toner image from the image carrier 65 to the recording medium P that is a to-be-transferred body. In detail, the transfer device 70 transfers each toner image formed on the surface of each image carrier 65 of the first image formation unit 62Y to the fourth image formation unit 62K onto the recording medium P in a superimposed manner. In the third embodiment, the transfer device 70 transfers each toner image onto the recording medium P in a superimposed manner using a secondary transfer method (intermediate transfer method). The transfer device 70 includes four primary transfer rollers 71, an intermediate transfer belt 72, a drive roller 73, a driven roller 74, and a secondary transfer roller 75.

The intermediate transfer belt 72 is an endless belt stretched over the four primary transfer rollers 71, the drive roller 73, and the driven roller 74. The intermediate transfer belt 72 is driven in accordance with rotation of the drive roller 73. The intermediate transfer belt 72 rotates counterclockwise in FIG. 8. The driven roller 74 is driven to rotate in accordance with the drive of the intermediate transfer belt 72.

The first image formation unit 62Y to the fourth image formation unit 62K are disposed to face the lower surface of the intermediate transfer belt 72. In the third embodiment, the first image formation unit 62Y to the fourth image formation unit 62K are disposed in the order of the first image formation unit 62Y to the fourth image formation unit 62K from the upstream side to the downstream side in a drive direction D of the lower surface of the intermediate transfer belt 72.

Each primary transfer roller 71 is disposed to face the corresponding image carrier 65 via the intermediate transfer belt 72 and is pressed toward the image carrier 65. For this reason, the toner image formed on the surface of each image carrier 65 by each primary transfer roller 71 is sequentially transferred onto the intermediate transfer belt 72. In the third embodiment, a yellow toner image, a cyan toner image, a magenta toner image, and a black toner image are transferred onto the intermediate transfer belt 72 in this order in a superimposed manner. Hereinafter, the toner image obtained by superimposing a yellow toner image, a cyan toner image, a magenta toner image, and a black toner image will be referred to as a “stacked toner image” in some cases.

The secondary transfer roller 75 is disposed to face the drive roller 73 via the intermediate transfer belt 72. The secondary transfer roller 75 is pressed toward the drive roller 73. This forms a transfer nip between the secondary transfer roller 75 and the drive roller 73. When the recording medium P passes through the transfer nip, the stacked toner image on the intermediate transfer belt 72 is transferred onto the recording medium P by the secondary transfer roller 75. In the third embodiment, a yellow toner image, a cyan toner image, a magenta toner image, and a black toner image are transferred onto the recording medium P in this order as the top layer to the bottom layer. The recording medium P onto which the stacked toner image has been transferred is conveyed toward the fixing device 80 by the conveying unit 40.

The fixing device 80 includes a heating member 81 and a pressure member 82. The heating member 81 and the pressure member 82 are disposed to face each other to form a fixing nip. The recording medium P conveyed from the image forming unit 60 is pressurized while being heated at a predetermined fixing temperature by passing through the fixing nip. As a result, the stacked toner image is fixed to the recording medium P. The recording medium P is conveyed from the fixing device 80 to the output unit 90 by the conveying unit 40.

The output unit 90 includes an output roller pair 91 and an output tray 93. The output roller pair 91 conveys the recording medium P to the output tray 93 via an output port 92. The output port 92 is formed in the upper part of the image forming apparatus 100.

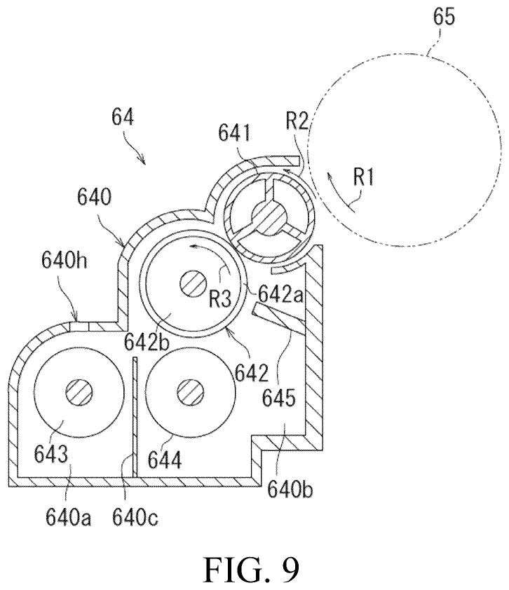

Next, a configuration of the development device 64 will be described in detail with reference to FIG. 9. FIG. 9 is a diagram showing an example of a configuration of the development device 64. In detail, FIG. 9 shows the development device 64 of the first image formation unit 62Y. Note that in FIG. 9, the image carrier 65 is illustrated by a two-dot chain line for ease of understanding. In the third embodiment, the development device 64 adopts a two-component development method using a two-component developer and a touch-down development method.

As described above with reference to FIG. 8, a development container 640 of the development device 64 is connected to the first toner container 52Y. Therefore, a yellow toner is supplied to the development container 640 of the development device 64 via a toner supply port 640h.

As shown in FIG. 9, the development device 64 includes, inside the development container 640, a development roller 641, a magnetic roller 642, a first stirring screw 643, a second stirring screw 644, and a blade 645. In detail, the development roller 641 is disposed to face the magnetic roller 642. The magnetic roller 642 is disposed to face the second stirring screw 644. The blade 645 is disposed to face the magnetic roller 642.

The development container 640 is divided into a first stirring chamber 640a and a second stirring chamber 640b by a partition wall 640c. The partition wall 640c extends in the axial direction of the development roller 641. The first stirring chamber 640a and the second stirring chamber 640b communicate with each other on the outside at both ends of the partition wall 640c in the longitudinal direction.

The first stirring screw 643 is disposed in the first stirring chamber 640a. A carrier that is a magnetic material is housed in the first stirring chamber 640a. A toner that is a non-magnetic material is supplied to the first stirring chamber 640a via the toner supply port 640h. In the example shown in FIG. 9, a yellow toner is supplied to the first stirring chamber 640a.

The second stirring screw 644 is disposed in the second stirring chamber 640b. A carrier that is a magnetic material is housed in the second stirring chamber 640b.

The yellow toner is stirred with the carrier by the first stirring screw 643 and the second stirring screw 644. As a result, a two-component developer that includes a carrier and a yellow toner is formed. In this way, the two-component developer is housed in the development container 640 (more specifically, the first stirring chamber 640a and the second stirring chamber 640b).

The first stirring screw 643 and the second stirring screw 644 stir the two-component developer while circulating it between the first stirring chamber 640a and the second stirring chamber 640b. As a result, the toner is charged to predetermined polarity by friction with the carrier.

Note that in the case where the image carrier 65 is the single-layer photoreceptor 1, the surface of the image carrier 65 and the toner are charged to, for example, positive polarity. In the case where the image carrier 65 is the stacked photoreceptor 10, the surface of the image carrier 65 and the toner are charged to, for example, negative polarity.

The magnetic roller 642 includes a non-magnetic rotating sleeve 642a and a magnet body 642b. The magnet body 642b is fixed to and disposed in the rotating sleeve 642a. The magnet body 642b includes a plurality of magnetic poles. The two-component developer is attracted to the magnetic roller 642 by the magnetic force of the magnet body 642b. As a result, a magnetic brush is formed on the surface of the magnetic roller 642.

The blade 645 is disposed on the upstream side in the rotation direction of the magnetic roller 642 than the position where the magnetic roller 642 and the development roller 641 face each other. In the third embodiment, the magnetic roller 642 rotates in the direction indicated by an arrow R3 in FIG. 9 (counterclockwise direction in FIG. 9). The magnetic roller 642 rotates to convey the magnetic brush to the position facing the blade 645. The blade 645 is disposed such that a gap is formed between the blade 645 and the magnetic roller 642. The blade 645 is formed of a magnetic material. Therefore, the thickness of the magnetic brush is regulated by the magnetic force of the blade 645.

After the thickness of the magnetic brush on the magnetic roller 642 is regulated, a predetermined voltage is applied to the magnetic roller 642 and the development roller 641. When the predetermined voltage is applied to obtain a predetermined potential difference between the magnetic roller 642 and the development roller 641, the yellow toner included in the two-component developer migrates to the development roller 641. As a result, the toner thin layer including the yellow toner is formed on the surface of the development roller 641.

The development roller 641 rotates in the direction indicated by an arrow R2 in FIG. 9 (counterclockwise direction in FIG. 9). This causes the toner thin layer formed on the surface of the development roller 641 to be conveyed to the position facing the image carrier 65 and adhere to the image carrier 65. In this way, the development device 64 supplies the toner charged due to the friction with the carrier to the surface of the image carrier 65.

The development device 64 of the first image formation unit 62Y has been described above with reference to FIG. 9. Regarding the configuration of the development device 64 of each of the first image formation unit 62Y to the fourth image formation unit 62K, only the type of toner to be supplied from the toner supply unit 50 differs and the other configurations are the same. For this reason, description of the configuration of the development device 64 of each of the second image formation unit 62C to the fourth image formation unit 62K is omitted.

The image forming apparatus 100 that is an example of the image forming apparatus according to the third embodiment has been described above with reference to FIG. 8 and FIG. 9. However, the image forming apparatus according to the third embodiment is not limited to the image forming apparatus 100. For example, the image forming apparatus may be a monochrome image forming apparatus. In this case, the image forming apparatus only needs to include one image formation unit. The image forming apparatus may adopt a rotary method. The charging device may be a charging device other than the charging roller (e.g., a scorotron charger, a charging brush, or a corotron charger). The image forming apparatus may adopt a one-component development method using a one-component developer. The image forming apparatus may adopt a development method other than the touch-down development method (e.g., a development method in which no development roller is provided and a magnetic roller serves also as a development roller). The image forming apparatus may adopt a direct transfer method. In the case where the image forming apparatus adopts a direct transfer method, a toner image is directly transferred to a recording medium from an image carrier while the image carrier is in contact with the recording medium. The image forming apparatus does not necessarily need to include a cleaning device. The image forming apparatus does not necessarily need to include a static elimination device. The image forming apparatus according to the third embodiment has been described above.

### Fourth Embodiment: Process Cartridge

Next, a first process cartridge 101, a second process cartridge 102, a third process cartridge 103, and a fourth process cartridge 104, which are examples of a process cartridge according to a fourth embodiment of the present invention, will be described with continued reference to FIG. 8. The first process cartridge 101 to the fourth process cartridge 104 according to the fourth embodiment respectively correspond to the first image formation unit 62Y to the fourth image formation unit 62K. Each of the first process cartridge 101 to the fourth process cartridge 104 includes the image carrier 65. The image carrier 65 is the photoreceptor according to the first embodiment (more specifically, the single-layer photoreceptor 1 and the stacked photoreceptor 10).

As described in the first embodiment, the photoreceptor according to the first embodiment is capable of sufficiently curing a protective layer even in the case where the protective layer includes a photocurable resin and has excellent potential stability. Therefore, the process cartridge according to the fourth embodiment can include a photoreceptor that is capable of sufficiently curing a protective layer even in the case where the protective layer includes a photocurable resin and has excellent potential stability.

The process cartridge according to the fourth embodiment may further include at least one (e.g., 1 or more and 7 or less) selected from the group consisting of the charging device 63, the exposure device 61, the development device 64, the transfer device 70 (particularly, the primary transfer roller 71), the cleaning member 661, the rubbing roller 662, and the static elimination device 67, in addition to the image carrier 65.

Each of the first process cartridge 101, the second process cartridge 102, the third process cartridge 103, and the fourth process cartridge 104 shown in FIG. 8 includes the image carrier 65, the charging device 63, the development device 64, the cleaning device 66 including the cleaning member 661 and the rubbing roller 662, and the static elimination device 67, similarly to the first image formation unit 62Y, the second image formation unit 62C, the third image formation unit 62M, and the fourth image formation unit 62K. However, the process cartridge according to the fourth embodiment is not limited to the first process cartridge 101 to the fourth process cartridge 104. As described above, the process cartridge according to the fourth embodiment may further include at least one of the exposure device 61 or the transfer device 70 and may include only one of the cleaning member 661 and the rubbing roller 662 (e.g. only the cleaning member 661). In any case, the process cartridge according to the fourth embodiment only needs to include the photoreceptor according to the first embodiment as the image carrier 65.

The process cartridge according to the fourth embodiment is designed to be attachable/detachable to/from the image forming apparatus 100. For this reason, the process cartridge is easy to handle, and can be easily and quickly replaced together with the image carrier 65 in the case where the sensitivity characteristics or the like of the image carrier 65 deteriorate. The process cartridge according to the fourth embodiment has been described above with reference to FIG. 8.

### [Substituent Group]

The substituent group used in the present specification will be described below. Examples of the halogen atom (halogen group) include a fluorine atom (fluoro group), a chlorine atom (chloro group), a bromine atom (bromo group), and an iodine atom (iodo group).

Unless otherwise specified, each of the alkyl group having 1 or more and 8 or less carbon atoms, the alkyl group having 1 or more and 6 or less carbon atoms, the alkyl group having 1 or more and 5 or less carbon atoms, and the alkyl group having 1 or more and 3 or less carbon atoms is linear or branched chain and unsubstituted. Examples of the alkyl group having 1 or more and 8 or less carbon atoms include a methyl group, an ethyl group, an n-propyl group, an isopropyl group, an n-butyl group, a sec-butyl group, a tert-butyl group, an n-pentyl group, a 1-methylbutyl group, a 2-methylbutyl group, a 3-methylbutyl group, a 1-ethylpropyl group, a 2-ethylpropyl group, a 1,1-dimethylpropyl group, a 1,2-dimethylpropyl group, a 2,2-dimethylpropyl group, an n-hexyl group, a 1-methylpentyl group, a 2-methylpentyl group, a 3-methylpentyl group, a 4-methylpentyl group, a 1,1-dimethylbutyl group, a 1,2-dimethylbutyl group, a 1,3-dimethylbutyl group, a 2,2-dimethylbutyl group, a 2,3-dimethylbutyl group, a 3,3-dimethylbutyl group, a 1,1,2-trimethylpropyl group, a 1,2,2-trimethylpropyl group, a 1-ethylbutyl group, a 2-ethylbutyl group, a 3-ethylbutyl group, linear and branched chain heptyl groups, and linear and branched chain octyl groups. Examples of the alkyl group having 1 or more and 6 or less carbon atoms, the alkyl group having 1 or more and 5 or less carbon atoms, and the alkyl group having 1 or more and 3 or less carbon atoms are groups having the corresponding number of carbon atoms, of the groups mentioned as the examples of the alkyl group having 1 or more and 8 or less carbon atoms.

Unless otherwise specified, the alkoxy group having 1 or more and 6 or less carbon atoms is linear or branched chain and unsubstituted. Examples of the alkoxy group having 1 or more and 6 or less carbon atoms include a methoxy group, an ethoxy group, an n-propoxy group, an isopropoxy group, an n-butoxy group, a sec-butoxy group, a tert-butoxy group, an n-pentoxy group, a 1-methylbutoxy group, a 2-methylbutoxy group, a 3-methylbutoxy group, a 1-ethylpropoxy group, a 2-ethylpropoxy group, a 1,1-a dimethylpropoxy group, a 1,2-dimethylpropoxy group, a 2,2-dimethylpropoxy group, an n-hexyloxy group, a 1-methylpentyloxy group, a 2-methylpentyloxy group, a 3-methylpentyloxy group, a 4-methylpentyloxy group, a 1,1-dimethylbutoxy group, a 1,2-dimethylbutoxy group, a 1,3-dimethylbutoxy group, a 2,2-dimethylbutoxy group, a 2,3-dimethylbutoxy group, a 3,3-dimethylbutoxy group, a 1,1,2-trimethylpropoxy group, a 1,2,2-trimethylpropoxy group, a 1-ethylbutoxy group, a 2-ethylbutoxy group, and a 3-ethylbutoxy group.

Unless otherwise specified, each of the aryl group having 6 or more and 14 or less carbon atoms and the aryl group having 6 or more and 10 or less carbon atoms is unsubstituted. Examples of the aryl group having 6 or more and 14 or less carbon atoms include a phenyl group, a naphthyl group, an indacenyl group, a biphenylenyl group, an acenaphthylenyl group, an anthryl group, and a phenanthryl group. Examples of the aryl group having 6 or more and 10 or less carbon atoms are groups having the corresponding number of carbon atoms, of the groups mentioned as the examples of the aryl group having 6 or more and 14 or less carbon atoms.

Unless otherwise specified, the alkenyl group having 2 or more and 6 or less carbon atoms is linear or branched chain and unsubstituted. The alkenyl group having 2 or more and 6 or less carbon atoms has 1 or more and 3 or less double bonds. Examples of the alkenyl group having 2 or more and 6 or less carbon atoms include an ethenyl group, a propenyl group, a butenyl group, a butadienyl group, a pentenyl group, a hexenyl group, a hexadienyl group, and a hexatrienyl group. The substituent group used in the present specification has been described above.

### Examples

Although the present invention will be further specifically described using Examples, the present invention is not limited to the scope of the Examples.

### [Production of Single-Layer Photoreceptor]

Single-layer photoreceptors having configurations shown in the following Table 1 to Table 3 were produced.

TABLE 1

| | | Single-layer Photosensitive layer | | | | | Protective layer | | | | |
|---|---|---|---|---|---|---|---|---|---|---|---|
| | | | | | | HTM + ETM | | | | | |
| | | | | | | content | Monomer | | | | Curing |
| | Single-layer | | | | | ratio | | Mass | | | conditions |
| | photoreceptor | CGM | HTM | ETM | Resin | (mass %) | Type | ratio | Metal Oxide | | (mW · s) |
| Comp 1 | B-1 | CG-1 | HT-1 | ET-1/ET-6 | BisZ | 40 | EA | 100 | PTO | Alumina | 5400 |
| Comp 2 | B-2 | CG-1 | HT-1 | ET-1/ET-6 | BisZ | 40 | EA | 100 | PTO | Alumina | 60300 |
| Comp 3 | B-3 | CG-1 | HT-2 | ET-1/ET-6 | BisZ | 40 | UA | 100 | PTO | Alumina | 86400 |
| Comp 4 | B-4 | CG-1 | HT-3 | ET-1/ET-6 | BisZ | 40 | UA | 100 | PTO | Alumina | 86400 |
| Comp 5 | B-5 | CG-1 | HT-1 | ET-1/ET-6 | BisZ | 40 | EA | 100 | PTO | Alumina | 86400 |
| Comp 6 | B-6 | CG-1 | HT-2 | ET-1/ET-6 | BisZ | 40 | EA | 100 | PTO | Alumina | 5400 |
| Ex 1 | A-1 | CG-1 | HT-2 | ET-1/ET-6 | BisZ | 40 | EA | 100 | PTO | Alumina | 60300 |
| Ex 2 | A-2 | CG-1 | HT-2 | ET-1/ET-6 | BisZ | 40 | EA | 100 | PTO | Alumina | 86400 |
| Comp 7 | B-7 | CG-1 | HT-3 | ET-1/ET-6 | BisZ | 40 | EA | 100 | PTO | Alumina | 5400 |
| Ex 3 | A-3 | CG-1 | HT-3 | ET-1/ET-6 | BisZ | 40 | EA | 100 | PTO | Alumina | 60300 |
| Ex 4 | A-4 | CG-1 | HT-3 | ET-1/ET-6 | BisZ | 40 | EA | 100 | PTO | Alumina | 86400 |
| Ex 5 | A-5 | CG-1 | HT-4 | ET-1/ET-6 | BisZ | 40 | EA | 100 | PTO | Alumina | 86400 |
| Ex 6 | A-6 | CG-1 | HT-2 | ET-1/ET-6 | BisZ | 40 | EA/UA | 60/40 | PTO | Alumina | 86400 |
| Comp 8 | B-8 | CG-1 | HT-2 | ET-1/ET-6 | BisZ | 40 | EA/UA | 40/60 | PTO | Alumina | 86400 |
| Ex 7 | A-7 | CG-1 | HT-2/HT-3 | ET-1/ET-6 | BisZ | 60 | EA | 100 | PTO | Alumina | 86400 |

TABLE 2

| | | Single-layer Photosensitive layer | | | | | Protective layer | | | | |
|---|---|---|---|---|---|---|---|---|---|---|---|
| | | | | | | HTM + ETM | | | | | |
| | | | | | | content | Monomer | | | | Curing |
| | Single-layer | | | | | ratio | | Mass | | | conditions |
| | photoreceptor | CGM | HTM | ETM | Resin | (mass %) | Type | ratio | Metal Oxide | | (mW · s) |
| Ex 8 | A-8 | CG-1 | HT-2 | ET-1 | BisZ | 40 | EA | 100 | PTO | Alumina | 60300 |
| Ex 9 | A-9 | CG-1 | HT-2 | ET-2 | BisZ | 40 | EA | 100 | PTO | Alumina | 60300 |
| Ex 10 | A-10 | CG-1 | HT-2 | ET-3 | BisZ | 40 | EA | 100 | PTO | Alumina | 60300 |
| Ex 11 | A-11 | CG-1 | HT-2 | ET-4 | BisZ | 40 | EA | 100 | PTO | Alumina | 60300 |
| Ex 12 | A-12 | CG-1 | HT-2 | ET-5 | BisZ | 40 | EA | 100 | PTO | Alumina | 60300 |
| Ex 13 | A-13 | CG-1 | HT-2 | ET-6 | BisZ | 40 | EA | 100 | PTO | Alumina | 60300 |
| Ex 14 | A-14 | CG-1 | HT-2 | ET-7 | BisZ | 40 | EA | 100 | PTO | Alumina | 60300 |
| Ex 15 | A-15 | CG-1 | HT-2 | ET-7 | BisB | 40 | EA | 100 | PTO | Alumina | 60300 |
| Comp 9 | B-9 | CG-2 | HT-1 | ET-1/ET-6 | BisZ | 40 | EA | 100 | PTO | Alumina | 86400 |
| Comp 10 | B-10 | CG-2 | HT-2 | ET-1/ET-6 | BisZ | 40 | EA | 100 | PTO | Alumina | 5400 |
| Ex 16 | A-16 | CG-2 | HT-2 | ET-1/ET-6 | BisZ | 40 | EA | 100 | PTO | Alumina | 60300 |
| Ex 17 | A-17 | CG-2 | HT-2 | ET-1/ET-6 | BisZ | 40 | EA | 100 | PTO | Alumina | 86400 |
| Comp 11 | B-11 | CG-2 | HT-3 | ET-1/ET-6 | BisZ | 40 | EA | 100 | PTO | Alumina | 5400 |
| Ex 18 | A-18 | CG-2 | HT-3 | ET-1/ET-6 | BisZ | 40 | EA | 100 | PTO | Alumina | 60300 |
| Ex 19 | A-19 | CG-2 | HT-3 | ET-1/ET-6 | BisZ | 40 | EA | 100 | PTO | Alumina | 86400 |

TABLE 3

| | | Single-layer Photosensitive layer | | | | | Protective layer | | | | |
|---|---|---|---|---|---|---|---|---|---|---|---|
| | | | | | | HTM + ETM | | | | | |
| | | | | | | content | Monomer | | | | Curing |
| | Single-layer | | | | | ratio | | Mass | | | conditions |
| | photoreceptor | CGM | HTM | ETM | Resin | (mass %) | Type | ratio | Metal Oxide | | (mW · s) |
| Ex 20 | A-20 | CG-2 | HT-4 | ET-1/ET-6 | BisZ | 40 | EA | 100 | PTO | Alumina | 86400 |
| Ex 21 | A-21 | CG-2 | HT-2 | ET-1/ET-6 | BisZ | 40 | EA/UA | 60/40 | PTO | Alumina | 86400 |
| Comp 12 | B-12 | CG-2 | HT-2 | ET-1/ET-6 | BisZ | 40 | EA/UA | 40/60 | PTO | Alumina | 86400 |
| Ex 22 | A-22 | CG-2 | HT-2 | ET-1/ET-6 | BisB | 40 | EA | 100 | PTO | Alumina | 60300 |
| Ex 23 | A-23 | CG-2 | HT-2/HT-3 | ET-1/ET-6 | BisZ | 60 | EA | 100 | PTO | Alumina | 86400 |
| Ex 24 | A-24 | CG-2 | HT-2 | ET-1 | BisZ | 40 | EA | 100 | PTO | Alumina | 60300 |
| Ex 25 | A-25 | CG-2 | HT-2 | ET-2 | BisZ | 40 | EA | 100 | PTO | Alumina | 60300 |
| Ex 26 | A-26 | CG-2 | HT-2 | ET-3 | BisZ | 40 | EA | 100 | PTO | Alumina | 60300 |
| Ex 27 | A-27 | CG-2 | HT-2 | ET-4 | BisZ | 40 | EA | 100 | PTO | Alumina | 60300 |
| Ex 28 | A-28 | CG-2 | HT-2 | ET-5 | BisZ | 40 | EA | 100 | PTO | Alumina | 60300 |
| Ex 29 | A-29 | CG-2 | HT-2 | ET-6 | BisZ | 40 | EA | 100 | PTO | Alumina | 60300 |
| Ex 30 | A-30 | CG-2 | HT-2 | ET-7 | BisZ | 40 | EA | 100 | PTO | Alumina | 60300 |
| Ex 31 | A-31 | CG-2 | HT-2 | ET-7 | BisB | 40 | EA | 100 | PTO | Alumina | 60300 |
| Ex 32 | A-32 | CG-1 | HT-2/HT-3 | ET-1/ET-6 | BisZ | 60 | EA | 100 | ATO | Alumina | 86400 |
| Ex 33 | A-33 | CG-2 | HT-2/HT-3 | ET-1/ET-6 | BisZ | 60 | EA | 100 | ATO | Alumina | 86400 |

The terms in Table 1 to Table 3 are as follows.
Ex: Example
Comp: Comparative Example
CGM: charge generating agent
HTM: hole transporting agent
ETM: electron transporting agent
HTM+ETM content ratio: the total content ratio of the hole transporting agent and the electron transporting agent occupied in the single-layer photosensitive layer with respect to the mass of the single-layer photosensitive layer
Curing conditions: light energy (unit: mW·s) of ultraviolet rays applied to the coating liquid for a protective layer in the protective layer forming step
CG-1: Y-type titanyl phthalocyanine
CG-2: X-type metal-free phthalocyanine
BisZ: bisphenol Z-type polycarbonate resin
BisB: bisphenol B-type polycarbonate resin
EA: multifunctional group acrylic acid ester (“A-DPH” manufactured by SHIN-NAKAMURA CHEMICAL CO, LTD., a mixture of a dipentaerythritol pentaacrylate and a dipentaerythritol hexaacrylate, a hydroxyl value of 10 mgKOH/g)
UA: urethane (meth)acrylate (“U-200P_{A}” manufactured by SHIN-NAKAMURA CHEMICAL CO, LTD.)
PTO: phosphorus-doped tin oxide (“SP-2” manufactured by Mitsubishi Materials Electronic Chemicals Co., Ltd., a BET specific surface area of 105±25 m²/g)
ATO: antimony-doped tin oxide (“T-1” manufactured by Mitsubishi Materials Electronic Chemicals Co., Ltd., a BET specific surface area: 77.5±7.5 m²/g, a number average primary particle size: 0.02 μm)
Alumina: alumina (“Al₂O₃” manufactured by CIK-Nano Tek, a BET specific surface area of 55 m²/g, a number average primary particle size of 31 nm)
Mass ratio of monomer:content ratio of the corresponding monomer occupied in the total mass of monomers for forming a photocurable resin
Hole transporting agent (HT-1): compound represented by the following formula (HT-1). The number of predetermined double bonds of this compound is four.

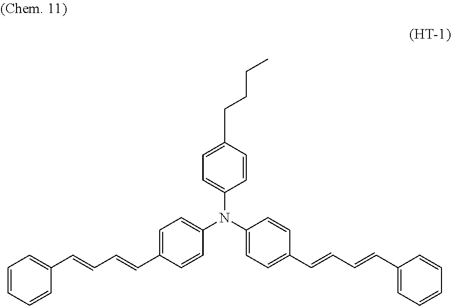 [SMILES: CCCCc1ccc(N(c2ccc(/C=C/C=C/c3ccccc3)cc2)c2ccc(/C=C/C=C/c3ccccc3)cc2)cc1]

### <Production of Single-Layer Photoreceptor (A-1)>

### (Formation of Intermediate Layer)

2 parts by mass of titanium oxide, 1 part by mass of a polyamide resin, 10 parts by mass of methanol, 1 part by mass of butanol, and 1 part by mass of toluene were mixed for 5 hours using a bead mill to obtain a mixed solution a. As titanium oxide, a prototype “SMT-A” manufactured by TAYCA Co., Ltd. (a number average primary particle size of 10 nm, obtained by performing primary surface treatment on titanium oxide using alumina and silica and performing secondary surface treatment on the titanium oxide subjected to the primary surface treatment using methylhydrogenpolysiloxane) was used. As a polyamide resin, “Amilan (registered trademark) CM8000” manufactured by TORAY INDUSTRIES, INC. (quaternary copolymerized polyamide resin of polyamide 6, polyamide 12, polyamide 66, and polyamide 610) was used. The obtained mixed solution a was filtered with a filter with an opening of 5 μm to obtain a coating liquid for an intermediate layer. Subsequently, the coating liquid for an intermediate layer was applied onto the surface of the conductive substrate by a dip coating method. As the conductive substrate, a drum-shaped support formed of aluminum was used. Subsequently, the applied coating liquid for an intermediate layer was dried at 130° C. for 30 minutes to form an intermediate layer (film thickness: 2 μm) on the conductive substrate.

### (Formation of Single-Layer Photosensitive Layer)

1.31 parts by mass of a Y-type titanyl phthalocyanine, 36.70 parts by mass of a hole transporting agent (HT-2), a total of 30.80 parts by mass of an electron transporting agent (more specifically, 15.40 parts by mass of an electron transporting agent (ET-1) and 15.40 parts by mass of an electron transporting agent (ET-6)), 100.00 parts by mass of a bisphenol Z-type polycarbonate resin, and 500.00 parts by mass of tetrahydrofuran were mixed for 20 minutes using a rod-shaped sonic oscillator to obtain a mixed solution b. The obtained mixed solution b was filtered with a filter with an opening of 5 μm to obtain a coating liquid for a single-layer photosensitive layer. Subsequently, the coating liquid for a single-layer photosensitive layer was applied onto the intermediate layer on the conductive substrate by a dip coating method. The applied coating liquid for a single-layer photosensitive layer was dried at 110° C. for 60 minutes to form a single-layer photosensitive layer (film thickness: 25 μm) on the intermediate layer. The total content ratio of the hole transporting agent and the electron transporting agent occupied in the single-layer photosensitive layer was 40 mass % with respect to the mass of the single-layer photosensitive layer.

### (Formation of Protective Layer)

3.5 parts by mass of alumina, 9.3 parts by mass of phosphorus-doped tin oxide (PTO), 90 parts by mass of multifunctional group acrylic acid ester as a monomer, 1 part by mass of a leveling agent, 10 parts by mass of a polymerization initiator, and 110 parts by mass of methanol were mixed for 10 hours using a bead mill to obtain a mixed solution c. As alumina, phosphorus-doped tin oxide, and multifunctional group acrylic acid ester, those described in the terms in the above Table were used. As a leveling agent, a UV curable fluorosilicon modified acrylic polymer having a vinyl group (“8FS-001” manufactured by TAISEI FINE CHEMICAL CO., LTD., a double bond equivalent (vinyl group equivalent): 420 g/mol) was used. As a polymerization initiator, a compound represented by the following formula (ST-1), i.e., 2,4,6-trimethylbenzoyl-diphenylphosphineoxide (“OMNIRAD TPO” manufactured by IGM Resins B.V.) was used. The obtained mixed solution c was filtered with a filter with an opening of 5 μm to obtain a coating liquid for a protective layer. Subsequently, the coating liquid for a protective layer was applied onto the single-layer photosensitive layer by a dip coating method. Ultraviolet rays having a wavelength of 365 nm were applied from a light-emitting diode light source to the applied coating liquid for a protective layer under the condition of light energy of 60300 mW·s. The application of ultraviolet rays polymerized (photocuring reaction) the multifunctional group acrylic acid ester and the leveling agent in the coating liquid for a protective layer to form a photocurable resin. In this way, a protective layer (film thickness: 3 μm) was formed on the single-layer photosensitive layer. The protective layer included the photocurable resin cured by the photocuring reaction, the alumina, the phosphorus-doped tin oxide, and the polymerization initiator.

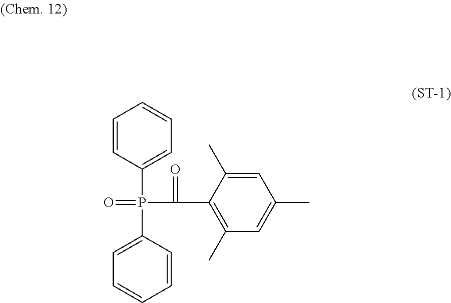 [SMILES: Cc1cc(C)c(C(=O)P(=O)(c2ccccc2)c2ccccc2)c(C)c1]

<Production of single-layer photoreceptors (A-2) to (A-33) and (B-1) to (B-12)>

Single-layer photoreceptors (A-2) to (A-33) and (B-1) to (B-12) were produced in the same manner as in the production of the single-layer photoreceptor (A-1) except that the following points were changed.

### (Formation of Single-Layer Photosensitive Layer)

In the formation of a single-layer photosensitive layer, the charge generating agent, the hole transporting agent, the electron transporting agent, and the binder resin shown in Table 1 to Table 3 were used. The hole transporting agent and the electron transporting agent were added in the amount that would make the total content ratio of the hole transporting agent and the electron transporting agent occupied in the single-layer photosensitive layer with respect to the mass of the single-layer photosensitive layer the value shown in Table 1 to Table 3. For example, in the case where the above-mentioned total content ratio of the hole transporting agent and the electron transporting agent is 40 mass % with respect to the mass of the single-layer photosensitive layer, a total of 36.70 parts by mass of the hole transporting agent and a total of 30.80 parts by mass of the electron transporting agent were used. In the case where the above-mentioned total content ratio of the hole transporting agent and the electron transporting agent is 60 mass % with respect to the mass of the single-layer photosensitive layer, a total of 84.00 parts by mass of the hole transporting agent and a total of 70.30 parts by mass of the electron transporting agent were used. Note that in the case where two types of hole transporting agents (HT-2) and (HT-3) were used, each hole transporting agent was used in the amount that would make the mass ratio HT-2/HT-3 1/1. In the case where two types of electron transporting agents (ET-1) and (ET-6) were used, each electron transporting agent was used in the amount that would make the mass ratio ET-1/ET-6 1/1.

### (Formation of Protective Layer)

In the formation of a protective layer, the monomer shown in Table 1 to Table 3 was used in the mass ratio shown in Tables 1 to 3. For example, in the case where the monomer type “EA” and the monomer mass ratio “100” were shown, 90 parts by mass of multifunctional group acrylic acid ester was used. In the case where the monomer type “UA” and the monomer mass ratio “100” were shown, 90 parts by mass of urethane (meth)acrylate was used. In the case where the monomer type “EA/UA” and the monomer mass ratio “60/40” were shown, 54 parts by mass of multifunctional group acrylic acid ester and 36 parts by mass of urethane (meth)acrylate were used. In the case where the monomer type “EA/UA” and the monomer mass ratio “40/60” were shown, 36 parts by mass of multifunctional group acrylic acid ester and 54 parts by mass of urethane (meth)acrylate were used. In the formation of a protective layer, the metal oxide shown in Table 1 to Table 3 was used. In the formation of a protective layer, ultraviolet rays at the light energy shown in Table 1 to Table 3 were applied. Note that In the formation of a protective layer, the wavelength of ultraviolet rays to be applied was remained unchanged at 365 nm.

### [Measurement of Single-Layer Photoreceptor]

The ratio A/B and the residual ratio Z of the hole transporting agent of each single-layer photoreceptor were measured by the following method. The measurement results are shown in Table 4 to Table 6.

### <Ratio A/B>

Each protective layer of the single-layer photoreceptors (A-1) to (A-33) and (B-1) to (B-12) was formed in the same manner as the formation of a protective layer of each of the single-layer photoreceptors (A-1) to (A-33) and (B-1) to (B-12) except that the coating liquid for a protective layer was directly applied onto the conductive substrate instead of onto the single-layer photosensitive layer. The protective layer was peeled off from the conductive substrate, and the peeled protective layer was used as Fourier transform infrared spectroscopy (FT-IR) measurement sample. The FT-IR measurement sample was measured using an FT-IR analyzer (“Spectrum one” manufactured by PerkinElmer) under the following measurement conditions to obtain an FT-IR spectrum. From the FT-IR spectrum, the highest absorbance (first absorbance A) within the wavenumber range of 1627 cm⁻¹ or more and 1647 cm⁻¹ or less and the highest absorbance (second absorbance B) within the wavenumber range more than 1647 cm⁻¹ and 1800 cm-r or less were obtained. Then, the ratio A/B was obtained from the calculation formula “ratio A/B=first absorbance A/second absorbance B”.

### (FT-IR Measurement Conditions)

Method: attenuated total reflection (ATR) method
Incidence angle: 45 degrees
Internal reflective element: germanium
Measurement wavenumber range: range from 650 cm⁻¹ to 4000 cm⁻¹
Number of scans: 4
Resolution: 4 cm⁻¹

### <Residual Ratio Z of Hole Transporting Agent>

100 parts by mass of a binder resin, 25 parts by mass of a hole transporting agent, and 2400 parts by mass of tetrahydrofuran were mixed using a rotating device for 24 hours to obtain a coating liquid for UV-Vis measurement. Subsequently, the coating liquid for UV-Vis measurement was applied onto an overhead projector (OHP) film using a wire bar and heated at 120° C. for 50 minutes. In this way, a hole transporting agent-containing layer (film thickness of 3 μm) was formed on the OHP film. A sample including the hole transporting agent-containing layer and the OHP film was used as a UV-Vis measurement sample. Two UV-Vis measurement samples were prepared, and the two prepared measurement samples were used as a UV-Vis measurement sample S1 and a UV-Vis measurement sample S2.

The UV-Vis measurement sample S1 was placed on a film holder of an ultraviolet-visible spectrophotometer (“U-3010” manufactured by Hitachi, Ltd.). The UV-Vis measurement sample S1 was measured using the above-ultraviolet-visible spectrophotometer under the following measurement conditions. In this way, an ultraviolet-visible light absorption spectrum (spectrum before irradiation of ultraviolet rays) was obtained.

Next, the predetermined ultraviolet rays were applied to the UV-Vis measurement sample S2. The wavelength of the predetermined ultraviolet rays was set to 365 nm, and the light energy was set to the same value as the light energy of ultraviolet rays applied in the protective layer forming step. The UV-Vis measurement sample S2 after the predetermined ultraviolet irradiation was placed on the above film holder of the ultraviolet-visible spectrophotometer. The UV-Vis measurement sample S2 after the predetermined ultraviolet irradiation was measured using the above ultraviolet-visible spectrophotometer under the following measurement conditions to obtain an ultraviolet-visible light absorption spectrum (spectrum after UV irradiation).

From the spectrum before irradiation of ultraviolet rays, the absorbance A1 at the predetermined wavelength W (wavelength of 365 nm that is the same as the wavelength of the predetermined ultraviolet rays) was obtained. The obtained absorbance A1 was regarded as the absorbance A1 of the hole transporting agent before the predetermined ultraviolet irradiation. Next, the absorbance A2 at the predetermined wavelength W was obtained from the spectrum after irradiation of ultraviolet rays. The obtained absorbance A2 was regarded as the absorbance A2 of the hole transporting agent after the predetermined ultraviolet irradiation. The residual ratio Z of the hole transporting agent was calculated from the absorbance A1 of the hole transporting agent before the predetermined ultraviolet irradiation and the absorbance A2 of the hole transporting agent after the predetermined ultraviolet irradiation on the basis of the calculation formula (I) described in the second embodiment.

### (UV-Vis Measurement Conditions)

Measurement wavelength range: range of 320.00 nm or more and 600.00 nm or less
Sampling interval: 1.00 nm
Slit width: 1 nm
Scanning speed: 300 nm/min

Note that the hole transporting agent and the binder resin used to prepare the UV-Vis measurement sample were the hole transporting agent and the binder resin used to produce each single-layer photoreceptor shown in Table 1 to Table 3. In the case where two types of hole transporting agents are used, the amount of the hole transporting agent was set such that the mass ratio used to produce each single-layer photoreceptor shown in Table 1 to Table 3 was obtained and the total amount was 25 parts by mass. The light energy of the predetermined ultraviolet rays applied to the ultraviolet-visible spectroscopy (UV-Vis) measurement sample S2 was set to the same value as the light energy of ultraviolet rays applied in the production of each single-layer photoreceptor shown in Table 1 to Table 3. For example, in the measurement of the residual ratio Z of the hole transporting agent of the single-layer photoreceptor (A-1), the hole transporting agent (HT-2) and the binder resin (bisphenol Z-type polycarbonate resin) were used and the light energy of ultraviolet rays applied to the UV-Vis measurement sample S2 was set to 60300 mW·s. Note that the wavelength of the predetermined ultraviolet rays applied to the UV-Vis measurement sample S2 and the predetermined wavelength W used to read absorbance were remained unchanged at 365 nm.

### [Evaluation of Single-Layer Photoreceptor]

Dot reproducibility and potential stability of each single-layer photoreceptor were evaluated by the following method. The evaluation results are shown in Table 1 to Table 3.

### <Evaluation Device and Evaluation Paper>

For evaluation of dot reproducibility and potential stability, a modified machine of a color multifunction device (“Taskalfa 356ci” manufactured by KYOCERA Document Solutions Inc.) was used as an evaluation device. This evaluation device was equipped with a charging roller including an epichlorohydrin resin in which conductive carbon was dispersed. The charge polarity of the charging roller was positive polarity, and the applied voltage of the charging roller was a direct current voltage. The development method was a two-component development method. The transfer method was an intermediate transfer method. This evaluation device was equipped with a cleaning blade, a rubbing roller, and a static elimination device. For the evaluation, copy paper (“Multipaper Super Economy+” sold by ASKUL Corporation) was used as paper.

### <Dot Reproducibility>

The dot reproducibility was evaluated in a high-temperature and high-humidity environment of a temperature of 32° C. and a relative humidity of 80% RH. The single-layer photoreceptor was mounted on the evaluation device. An image G1 (image with image density of 1.6%) was printed on a sheet of paper using the evaluation device. The image densities (ID) of 10 positions randomly selected from the printed dots were measured and the number average value thereof was used as an evaluation value. Fort the measurement of image density, a reflection densitometer (“TC-6MC” manufactured by TokyoDenshoku. co., Ltd.) was used.

### (Criteria for Dot Reproducibility)

Good (A): The evaluation value is 0.01 or more and less than 0.02.
Poor (B): The evaluation value is less than 0.01.

### <Potential Stability>

The potential stability was evaluated in an environment of a temperature of 23° C. and a relative humidity of 50% RH. The single-layer photoreceptor was mounted on the evaluation device. The evaluation device was set such that the charging potential of the single-layer photoreceptor was +500 V. The exposure amount of the exposure device when printing a solid image was set to 1.08 μJ/cm².

An image G2 (solid image) was printed on a sheet of paper using the evaluation device. During printing, the surface potential (potential VL1 after initial exposure) of the single-layer photoreceptor after exposure was measured. Subsequently, an image G3 (image with a coverage rate of 5%) was continuously printed for 60 minutes using the evaluation device. Subsequently, the image G2 (solid image) was printed on a sheet of paper using the evaluation device after the printing for 60 minutes. During printing, the surface potential (post-exposure potential VL2 after continuous printing) of the single-layer photoreceptor after exposure was measured. An absolute value ΔVL of the amount of change in the post-exposure potential before and after the continuous printing was obtained from the calculation formula “ΔVL=|VL2−VL1|”. The potential stability was then evaluated in accordance with the following criteria.

### (Criteria for Potential Stability)

Good: ΔVL is 20 V or less.
Poor: ΔVL exceeds 20 V.

TABLE 4

| | Single-layer | | HTM | Dot | Potential |
|---|---|---|---|---|---|
| | photore- | Ratio | residual | reproduc- | stability |
| | ceptor | A/B | ratio Z (%) | ibility | Δ VL [V] |
| Comp 1 | B-1 | 0.172 | 97.0 | Curing failure | |
| Comp 2 | B-2 | 0.147 | 58.5 | A | 30 |
| Comp 3 | B-3 | 0.190 | 80.0 | A | 22 |
| Comp 4 | B-4 | 0.190 | 87.3 | A | 24 |
| Comp 5 | B-5 | 0.150 | 49.0 | A | 30 |
| Comp 6 | B-6 | 0.172 | 99.0 | Curing failure | |
| Ex 1 | A-1 | 0.147 | 97.1 | A | 18 |
| Ex 2 | A-2 | 0.150 | 82.0 | A | 20 |
| Comp 7 | B-7 | 0.172 | 96.0 | Curing failure | |
| Ex 3 | A-3 | 0.147 | 87.3 | A | 12 |
| Ex 4 | A-4 | 0.150 | 80.0 | A | 20 |
| Ex 5 | A-5 | 0.152 | 85.0 | A | 18 |
| Ex 6 | A-6 | 0.159 | 80.0 | A | 16 |
| Comp 8 | B-8 | 0.168 | 80.0 | A | 23 |
| Ex 7 | A-7 | 0.156 | 83.0 | A | 10 |

TABLE 5

| | Single-layer | | HTM | Dot | Potential |
|---|---|---|---|---|---|
| | photore- | Ratio | residual | reproduc- | stability |
| | ceptor | A/B | ratio Z (%) | ibility | Δ VL [V] |
| Ex 8 | A-8 | 0.147 | 85.4 | A | 15 |
| Ex 9 | A-9 | 0.147 | 85.4 | A | 20 |
| Ex 10 | A-10 | 0.147 | 85.4 | A | 19 |
| Ex 11 | A-11 | 0.147 | 85.4 | A | 19 |
| Ex 12 | A-12 | 0.147 | 85.4 | A | 17 |
| Ex 13 | A-13 | 0.147 | 85.4 | A | 13 |
| Ex 14 | A-14 | 0.147 | 85.4 | A | 13 |
| Ex 15 | A-15 | 0.147 | 85.4 | A | 17 |
| Comp 9 | B-9 | 0.150 | 49.0 | A | 34 |
| Comp 10 | B-10 | 0.172 | 99.0 | Curing failure | |
| Ex 16 | A-16 | 0.147 | 97.1 | A | 20 |
| Ex 17 | A-17 | 0.150 | 82.0 | A | 19 |
| Comp 11 | B-11 | 0.172 | 96.0 | Curing failure | |
| Ex 18 | A-18 | 0.147 | 87.3 | A | 15 |
| Ex 19 | A-19 | 0.150 | 80.0 | A | 19 |

TABLE 6

| | Single-layer | | HTM | Dot | Potential |
|---|---|---|---|---|---|
| | photore- | Ratio | residual | reproduc- | stability |
| | ceptor | A/B | ratio Z (%) | ibility | Δ VL [V] |
| Ex 20 | A-20 | 0.152 | 85.0 | A | 20 |
| Ex 21 | A-21 | 0.159 | 80.0 | A | 18 |
| Comp 12 | B-12 | 0.168 | 80.0 | A | 27 |
| Ex 22 | A-22 | 0.147 | 85.4 | A | 19 |
| Ex 23 | A-23 | 0.156 | 83.0 | A | 12 |
| Ex 24 | A-24 | 0.147 | 85.4 | A | 18 |
| Ex 25 | A-25 | 0.147 | 85.4 | A | 20 |
| Ex 26 | A-26 | 0.147 | 85.4 | A | 19 |
| Ex 27 | A-27 | 0.147 | 85.4 | A | 19 |
| Ex 28 | A-28 | 0.147 | 85.4 | A | 19 |
| Ex 29 | A-29 | 0.147 | 85.4 | A | 15 |
| Ex 30 | A-30 | 0.147 | 85.4 | A | 16 |
| Ex 31 | A-31 | 0.147 | 85.4 | A | 19 |
| Ex 32 | A-32 | 0.156 | 83.0 | A | 9 |
| Ex 33 | A-33 | 0.156 | 83.0 | A | 8 |

The terms in Table 4 to Table 6 are as follows. Note that “Ex” and “Comp” are synonymous with those described for the terms in above Table 1 to Table 3.

### HTM Residual Ratio Z: The Residual Ratio Z of the Hole Transporting Agent

Curing failure: Although ultraviolet rays were applied in the protective layer forming step, curing of the photocurable resin did not progress well, a curing failure of the protective layer was caused, and thus, evaluation of the single-layer photoreceptor could not be performed.

As shown in Table 1 to Table 3, the number of predetermined double bonds of the hole transporting agent included in the single-layer photosensitive layer of each of the single-layer photoreceptors (B-1), (B-2), (B-5), and (B-9) was three or more. As shown in Table 4 to Table 6, the ratio A/B of the protective layer included in each of the single-layer photoreceptors (B-1), (B-3), (B-4), (B-6), (B-7), (B-8), (B-10), (B-11), and (B-12) exceeded 0.160. As shown in Table 4 to Table 6, in the single-layer photoreceptors (B-1), (B-6), (B-7), (B-10), and (B-11), a curing failure of the protective layer was caused and thus, a single-layer photoreceptor could not be formed. As shown in Table 4 to Table 6, the potential stability of each of the single-layer photoreceptors (B-2), (B-3), (B-4), (B-5), (B-8), (B-9), and (B-12) was poor.

Meanwhile, as shown in Table 1 to Table 3, the hole transporting agent included in the single-layer photosensitive layer of each of the single-layer photoreceptor (A-1) to (A-33) had two or less predetermined double bonds or no predetermined double bond. The ratio A/B of the protective layer of each of the single-layer photoreceptors (A-1) to (A-33) was 0.160 or less. As shown in Table 1 to Table 3, each of the single-layer photoreceptors (A-1) to (A-33) was capable of sufficiently curing a protective layer even in the case where the protective layer includes a photocurable resin and had excellent potential stability. Further, in the single-layer photoreceptors (A-1) to (A-33), the dot reproducibility was maintained without being deteriorated.

### [Production of Stacked Photoreceptor]

A stacked photoreceptor having the configuration shown in the following Table 7 was produced.

TABLE 7

| | | | Charge transporting layer | | | Protective layer | | | | |
|---|---|---|---|---|---|---|---|---|---|---|
| | | Charge | | | HTM | | | | | |
| | | generating | | | content | Monomer | | | | Curing |
| | Stacked | layer | | | ratio | | Mass | | | conditions |
| | photoreceptor | CGM | HTM | Resin | (mass %) | Type | ratio | Metal Oxide | | (mW · s) |
| Ex 34 | C-1 | CG-1 | HT-2/HT-3 | BisZ | 40 | EA | 100 | PTO | Alumina | 86400 |
| Ex 35 | C-2 | CG-1 | HT-2/HT-3 | BisZ | 60 | EA | 100 | PTO | Alumina | 86400 |

### <Production of Stacked Photoreceptor (C-1)>

### (Formation of Intermediate Layer)

An intermediate layer was formed in the same manner as in the formation of the intermediate layer of the single-layer photoreceptor (A-1) except that the application condition of the dip coating method (speed at which the conductive substrate is pulled up from the coating liquid for an intermediate layer) was changed and the film thickness of the intermediate layer was changed to 0.5 μm.

### (Formation of Charge Generating Layer)

1.5 parts by mass of a Y-type titanyl phthalocyanine, 1 part by mass of a polyvinylacetal resin (“S-LEC BX-5” manufactured by SEKISUI CHEMICAL CO., LTD.) as a base resin, 40 parts by mass of propylene glycol monomethylether, and 40 parts by mass of tetrahydrofuran were mixed using a bead mill for 12 hours to obtain a mixed solution d. The obtained mixed solution d was filtered with a filter with an opening of 3 μm to obtain a coating liquid for a charge generating layer. Subsequently, the coating liquid for a charge generating layer was applied onto the intermediate layer on the conductive substrate by a dip coating method. The applied coating liquid for a charge generating layer was dried at 50° C. for 5 minutes to form a charge generating layer (film thickness: 0.3 μm) on the intermediate layer.

### (Formation of Charge Transporting Layer)

A total of 68.00 parts by mass of a hole transporting agent (more specifically, 45.30 parts by mass of a hole transporting agent (HT-2) and 22.70 parts by mass of a hole transporting agent (HT-3)), 100.00 parts by mass of a bisphenol Z-type polycarbonate resin, 0.05 parts by mass of a leveling agent, 340.00 parts by mass of tetrahydrofuran, and 60.00 parts by mass of toluene were mixed using a roll mill for 24 hours to obtain a coating liquid for a charge transporting layer. As a leveling agent, dimethylsilicone oil (“KF96-50CS” manufactured by Shin-Etsu Chemical Co., Ltd.) was used. Subsequently, the coating liquid for a charge transporting layer was applied onto the charge generating layer by a dip coating method. The applied coating liquid for a charge transporting layer was dried at 120° C. for 40 minutes to form a charge transporting layer (film thickness: 25 μm) on the charge generating layer. The total content ratio of the hole transporting agent occupied in the charge transporting layer was 40 mass % with respect to the mass of the charge transporting layer.

### (Formation of Protective Layer)

A protective layer was formed in the same manner as in the formation of the protective layer of the single-layer photoreceptor (A-1) except that the coating liquid for a protective layer was applied onto the charge transporting layer instead of onto the single-layer photosensitive layer and ultraviolet rays were applied at the light energy shown in Table 7.

### <Production of Stacked Photoreceptor (C-2)>

A stacked photoreceptor (C-2) was produced in the same manner as in the production of the stacked photoreceptor (C-1) except that a total of 68.00 parts by mass of a hole transporting agent (more specifically, 45.30 parts by mass of a hole transporting agent (HT-2) and 22.70 parts by mass of a hole transporting agent (HT-3)) was changed to a total of 150.00 parts by mass of a hole transporting agent (more specifically, 90.00 parts by mass of a hole transporting agent (HT-2) and 60.00 parts by mass of a hole transporting agent (HT-3)). The total content ratio of the hole transporting agent occupied in the charge transporting layer of the stacked photoreceptor (C-2) was 60 mass % with respect to the mass of the charge transporting layer.

### [Measurement of Stacked Photoreceptor]

The ratio A/B and the residual ratio Z of the hole transporting agent of each stacked photoreceptor were measured by the following method. The measurement results are shown in Table 8.

### <Ratio A/B>

The ratio A/B of the stacked photoreceptor was measured in the same manner as in the measurement of the ratio A/B of the single-layer photoreceptor except that the following samples were used as FT-IR measurement samples. A protective layer of each of stacked photoreceptors (C-1) to (C-2) was formed in the same manner as in the formation of the protective layer of each of the stacked photoreceptors (C-1) to (C-2) described above except that the coating liquid for a protective layer was directly applied onto the conductive substrate instead of onto the charge transporting layer. The protective layer was peeled off from the conductive substrate, and the peeled protective layer was used as an FT-IR measurement sample.

### <Residual Ratio Z of Hole Transporting Agent>

The residual ratio Z of the hole transporting agent of the stacked photoreceptor was measured in the same manner as in the measurement of the residual ratio Z of the hole transporting agent of the single-layer photoreceptor except that the following points were changed. The hole transporting agent and the binder resin used in the measurement of the residual ratio Z of the hole transporting agent of each stacked photoreceptor were the hole transporting agent and the binder resin shown in Table 7, which were used to produce each stacked photoreceptor. In the case where two types of hole transporting agents were used, the amount of the hole transporting agent was set such that the mass ratio of the hole transporting agent used to produce each stacked photoreceptor shown in Table 7 was obtained and the total amount of the hole transporting agent was 25 parts by mass. The light energy of ultraviolet rays applied to the UV-Vis measurement sample S2 was set to the same value as the light energy of ultraviolet rays applied in the production of each stacked photoreceptor shown in Table 7.

### [Evaluation of Stacked Photoreceptor]

The dot reproducibility and potential stability of each stacked photoreceptor were evaluated by the following method. The evaluation results are shown in Table 8.

### <Evaluation Device and Evaluation Paper>

An evaluation device similar to that used to evaluate the single-layer photoreceptor except that the charge polarity of the charging roller was modified from the positive polarity to the negative polarity was used to evaluate the stacked photoreceptor. Evaluation paper similar to that used to evaluate the single-layer photoreceptor was used to evaluate the stacked photoreceptor.

### <Dot Reproducibility>

The dot reproducibility of the stacked photoreceptor was evaluated in the same manner as in the evaluation of dot reproducibility of the single-layer photoreceptor.

### <Potential Stability>

The potential stability of the stacked photoreceptor was evaluated in the same manner as in the evaluation of the potential stability of the single-layer photoreceptor except that the evaluation device was set such that the charging potential of the stacked photoreceptor was −500 V.

TABLE 8

| | Stacked | | HTM | Dot | Potential |
|---|---|---|---|---|---|
| | photore- | Resin | residual | reproduc- | stability |
| | ceptor | A/B | ratio Z (%) | ibility | Δ VL [V] |
| Ex 34 | C-1 | 0.156 | 76.0 | A | 10 |
| Ex 35 | C-2 | 0.156 | 73.0 | A | 7 |

In Table 8, “Ex” and “HTM residual ratio Z” are synonymous with those described in the terms in the above Table 1 to Table 6.

As shown in Table 7, the hole transporting agent included in the charge transporting layer of each of the stacked photoreceptors (C-1) to (C-2) had two or less predetermined double bonds or no predetermined double bond. As shown in Table 8, the ratio A/B of the protective layer of each of the stacked photoreceptors (C-1) to (C-2) was 0.160 or less. As shown in Table 8, each of the stacked photoreceptors (C-1) to (C-2) was capable of sufficiently curing a protective layer even in the case where the protective layer includes a photocurable resin and had excellent potential stability. Further, in the stacked photoreceptors (C-1) to (C-2), the dot reproducibility was maintained without being deteriorated.

From the above, it has been shown that the photoreceptor according to the present invention, which includes the single-layer photoreceptors (A-1) to (A-33) and the stacked photoreceptors (C-1) to (C-2), is capable of sufficiently curing a protective layer even in the case where the protective layer includes a photocurable resin and has excellent potential stability. Further, the process cartridge and image forming apparatus according to the present invention include such a photoreceptor, and thus, it can be judged that they include a photoreceptor that is capable of sufficiently curing a protective layer even in the case where the protective layer includes a photocurable resin and has excellent potential stability.

### INDUSTRIAL APPLICABILITY

The photoreceptor according to the present invention can be used in an image forming apparatus. The process cartridge and image forming apparatus according to the present invention can be used to form an image on a recording medium.

1. An electrophotographic photoreceptor, comprising:
a conductive substrate;
a photosensitive layer; and
a protective layer,
the photosensitive layer including a charge generating agent, a hole transporting agent, and a binder resin,
the hole transporting agent having two or less chain ethene-1,2-diyl groups or no chain ethene-1,2-diyl group,
the protective layer being a top surface layer of the electrophotographic photoreceptor and including a photocurable resin,
a ratio A/B of first absorbance A of the protective layer to second absorbance B of the protective layer being 0.160 or less, the first absorbance and the second absorbance being measured by Fourier transform infrared spectroscopy,
the first absorbance being the highest absorbance in a wavenumber range of 1627 cm⁻¹ or more and 1647 cm⁻¹ or less,
the second absorbance being the highest absorbance in a wavenumber range of more than 1647 cm⁻¹ and 1800 cm⁻¹ or less.

2. The electrophotographic photoreceptor according to claim 1, wherein
the ratio A/B is 0.100 or more and 0.160 or less.

3. The electrophotographic photoreceptor according to claim 1, wherein
the hole transporting agent includes at least one of compounds represented by formulae (1), (2), and (3) 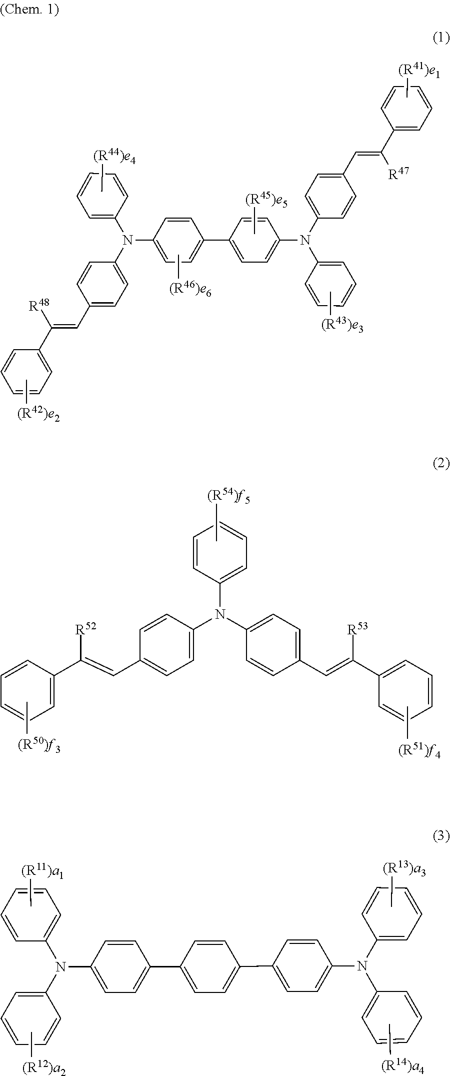
in the formula (1), R⁴¹, R⁴², R⁴³, R⁴⁴, R⁴⁵, and R⁴⁶ each independently represent an alkyl group having 1 or more and 8 or less carbon atoms or a phenyl group, R⁴⁷ and R⁴⁸ each independently represent a hydrogen atom, an alkyl group having 1 or more and 8 or less carbon atoms, or a phenyl group, e₁, e₂, e₃, and e₄ each independently represent an integer of 0 or more and 5 or less, and e₅ and e₆ each independently represent an integer of 0 or more and 4 or less,
in the formula (2), R⁵⁰, R⁵¹, and R⁵⁴ each independently represent an alkyl group having 1 or more and 8 or less carbon atoms or a phenyl group, R⁵² and R⁵³ each independently represent a hydrogen atom, an alkyl group having 1 or more and 8 or less carbon atoms, or a phenyl group that may be substituted with an alkyl group having 1 or more and 8 or less carbon atoms, and f₃, f₄, and f₅ each independently represent an integer of 0 or more and 5 or less, and
in the formula (3), R¹¹, R¹², R¹³, and R¹⁴ each independently represent an alkyl group having 1 or more and 8 or less carbon atoms or a phenyl group, and a₁, a₂, a₃, and a₄ each independently represent an integer of 0 or more and 5 or less.

4. The electrophotographic photoreceptor according to claim 1, wherein
the photocurable resin has a vinyl group and a carbonyl group,
the first absorbance is absorbance of a peak based on the vinyl group, and
the second absorbance is absorbance of a peak based on the carbonyl group.

5. The electrophotographic photoreceptor according to claim 1, wherein
the photocurable resin includes a repeating unit derived from (meth)acrylic acid ester, and the (meth)acrylic acid ester has 2 or more and 6 or less vinyl groups.

6. The electrophotographic photoreceptor according to claim 5, wherein
a content ratio of the repeating unit derived from (meth)acrylic acid ester occupied in all repeating units included in the photocurable resin is 60 mass % or more.

7. The electrophotographic photoreceptor according to claim 5, wherein
the photocurable resin further includes a repeating unit derived from urethane (meth)acrylate.

8. The electrophotographic photoreceptor according to claim 1, wherein
the protective layer further includes two types of metal oxides.

9. The electrophotographic photoreceptor according to claim 8, wherein
one of the two types of metal oxides is alumina.

10. The electrophotographic photoreceptor according to claim 9, wherein
the other of the two types of metal oxides is phosphorus-doped tin oxide or antimony-doped tin oxide.

11. The electrophotographic photoreceptor according to claim 1, wherein
a thickness of the protective layer is 2 μm or more.

12. The electrophotographic photoreceptor according to claim 1, wherein
the charge generating agent included in the photosensitive layer contains titanyl phthalocyanine or metal-free phthalocyanine.

13. A method of producing the electrophotographic photoreceptor according to claim 1, comprising:
a protective layer forming step of forming the protective layer including the photocurable resin on the photosensitive layer,
in the protective layer forming step, the photocurable resin being formed by applying ultraviolet rays to at least one of a monomer or an oligomer on the photosensitive layer to polymerize the at least one of the monomer or the oligomer.

14. A process cartridge, comprising:
at least one selected from the group consisting of a charging device, an exposure device, a development device, a transfer device, a cleaning member, a rubbing roller, and a static elimination device; and
the electrophotographic photoreceptor according to claim 1.

15. An image forming apparatus, comprising:
an image carrier;
a charging device that charges a surface of the image carrier;
an exposure device that exposes the charged surface of the image carrier to form an electrostatic latent image on the surface of the image carrier;
a development device that supplies a toner to the surface of the image carrier to develop the electrostatic latent image as a toner image; and
a transfer device that transfers the toner image from the image carrier onto a to-be-transferred body,
the image carrier being the electrophotographic photoreceptor according to claim 1.
